(19) United States
(12) Patent Application Publication
(10) Pub. No.: US 2025/0104290 A1
(43) Pub. Date: Mar. 27, 2025

(54) AUTOMATIC IMAGE GENERATION USING LATENT STRUCTURAL DIFFUSION

(71) Applicants: Erli Ding, Santa Monica, CA (US); Colin Eles, Marina del Rey, CA (US); Amir Fruchtman, Holon (IL); Riza Alp Guler, London (GB); Yanyu Li, Malden, MA (US); Xian Liu, Los Angeles, CA (US); Ergeta Muca, Long Island City, NY (US); Mohammad Rami Koujan, Hitchin (GB); Jian Ren, Marina Del Ray, CA (US); Dhritiman Sagar, Marina del Rey, CA (US); Aliaksandr Siarohin, Santa Monica, CA (US); Ivan Skorokhodov, Thuwal (SA); Sergey Tulyakov, Santa Monica, CA (US)

(72) Inventors: Erli Ding, Santa Monica, CA (US); Colin Eles, Marina del Rey, CA (US); Amir Fruchtman, Holon (IL); Riza Alp Guler, London (GB); Yanyu Li, Malden, MA (US); Xian Liu, Los Angeles, CA (US); Ergeta Muca, Long Island City, NY (US); Mohammad Rami Koujan, Hitchin (GB); Jian Ren, Marina Del Ray, CA (US); Dhritiman Sagar, Marina del Rey, CA (US); Aliaksandr Siarohin, Santa Monica, CA (US); Ivan Skorokhodov, Thuwal (SA); Sergey Tulyakov, Santa Monica, CA (US)

(21) Appl. No.: 18/429,251

(22) Filed: Jan. 31, 2024

Related U.S. Application Data
(60) Provisional application No. 63/585,902, filed on Sep. 27, 2023.

(51) Int. Cl. G06T 11/00; G06V 10/44

(52) U.S. Cl. CPC G06T 11/00; G06V 10/44

(57) ABSTRACT

Examples described herein relate to automatic image generation. A plurality of inputs is accessed. The inputs include first input data and second input data. The first input data includes a text prompt describing a desired image and the second input data is indicative of one or more structural features of the desired image. One or more intermediate outputs are generated via a first generative machine learning model that uses the plurality of inputs as first control signals. An output image is generated via a second generative machine learning model that uses at least a subset of the plurality of inputs and at least a subset of the one or more intermediate outputs as second control signals. The output image is presented at a user device of a user.

### CLAIM OF PRIORITY

This application claims the benefit of priority to U.S. Provisional Application Ser. No. 63/585,902, filed on Sep. 27, 2023, which is incorporated herein by reference in its entirety.

### TECHNICAL FIELD

Subject matter disclosed herein relates to techniques for automated image generation. Subject matter disclosed herein also relates to an interaction system that is configured to implement such techniques for automated image generation.

### BACKGROUND

The field of generative artificial intelligence (AI) continues to grow. Some generative AI systems are capable of automatically generating images. For example, machine learning models known as text-to-image models can be trained to process natural language descriptions (often referred to as “prompts”) and automatically generate corresponding visual outputs (e.g., an image depicting a scene described in a prompt).

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of an interaction system, according to some examples, that has both client-side and server-side functionality.

FIG. 3 diagrammatically illustrates a machine learning pipeline, according to some examples.

FIG. 4 diagrammatically illustrates training and use of a machine learning program, according to some examples.

FIG. 5 diagrammatically illustrates aspects of training of a latent structural diffusion model, according to some examples.

FIG. 6 diagrammatically illustrates generation of a surface normal map, a depth map, and a predicted color image by a first generative machine learning model, based on inputs that include a pose map and a text prompt, according to some examples.

FIG. 7 diagrammatically illustrates expert branches, shared layers, and connections within the first generative machine learning model of FIG. 6, according to some examples.

FIG. 8 shows a learning target formula, according to some examples.

FIG. 9 shows a learning target formula, according to some examples.

FIG. 10 diagrammatically illustrates generation of an output image by a second generative machine learning model, based on inputs that include the text prompt, the pose map, the surface normal map, and the depth map of FIG. 6, according to some examples.

FIG. 11 is a flowchart illustrating a method suitable for automatically generating an image, according to some examples.

FIG. 12 diagrammatically illustrates the generation of the image in the method of FIG. 11 in the context of the networked environment of FIG. 1, according to some examples.

FIG. 13 is a diagrammatic representation of a data structure as maintained in a database, according to some examples.

FIG. 14 is a diagrammatic representation of a message, according to some examples.

FIG. 15 illustrates a networked environment in which a head-wearable apparatus can be implemented according to some examples.

FIG. 16 is a diagrammatic representation of a machine in the form of a computer system within which a set of instructions may be executed to cause the machine to perform any one or more of the methodologies discussed herein, according to some examples.

FIG. 17 is a block diagram showing a software architecture within which examples may be implemented.

### DETAILED DESCRIPTION

Some automated image generators, such as generators built on diffusion models or Generative Adversarial Networks (GANs), can generate high-quality images in response to a user's prompts. However, achieving realistic image generation remains technically challenging. In particular (but not exclusively), the generation of hyperrealistic images that include humans (referred to herein simply as “human images”) is an ongoing challenge.

Text-to-image diffusion models, such as Stable Diffusion, may struggle to generate high-fidelity and anatomically coherent human images from text prompts alone. One reason for this is that, at least in some cases, human images have complex articulated structures that are difficult to capture from sparse or largely thematic text descriptions. In other words, a human is articulated with nonrigid deformations, requiring structural information that is difficult to convey via text prompts.

Examples described herein provide a technical solution for high-quality image generation, such as human image generation. While examples described herein may focus on human image generation, it will be appreciated that similar techniques may be applied to improve the generation of images that do not necessarily include humans or human features. For example, non-human animals and even inanimate objects, such as furniture, may also have inherently complex articulated structures, and techniques described herein may thus also provide improvements in the generation of images that depict non-human objects or items.

To address or alleviate at least some technical challenges in the generation of high-quality human images, examples described herein leverage the insight that a human image (or similarly structured images, such as a non-human animal image) is inherently structural over multiple granularities, for example, from a coarse-level body skeleton to fine-grained spatial geometry. Therefore, capturing such correlations between an explicit appearance and a latent structure in a machine learning model may facilitate generation of coherent, natural, or higher-quality human images.

Examples described herein apply a latent diffusion model. Generally, a latent diffusion model can reduce computational load by performing a denoising process in a latent space. For example, the latent space can be encoded from a pre-trained Variational Autoencoder (VAE). During inference, an image is constructed through a decoder from latent features. Conventionally, a latent diffusion model performs text-to-image generation, where a text prompt embedding is fed into the latent diffusion model as condition.

Examples described herein extend or improve such a conventional latent diffusion model by adding explicit structural information as a further condition. For example, the latent diffusion model can be trained to denoise not only the explicit appearance of an image (e.g., RGB (Red, Green, and Blue) values), but also structural aspects such as depth information or surface normal information, by further conditioning generation on structural information, such as a pose map that provides an indication of structural features of one or more humans to be depicted in the output image.

Accordingly, examples described herein provide a latent diffusion model that may be referred to as a latent “structural” diffusional model. In this context, the term “structural” indicates that a model is designed to capture, process, and/or more clearly reflect structural features of a desired image. In the case of human image generation, for example, structural features may include the anatomy, pose, or geometry of a human figure, spatial relationships within an image, or combinations thereof.

A unified model framework is described herein. The framework may be used to generate human images with a relatively high degree of realism and diverse layouts, including “in-the-wild” images (e.g., images that aim to provide natural, real-world settings). A large-scale human-centric dataset is also described herein to illustrate a suitable dataset that can be employed within the framework. The dataset may include images with comprehensive annotations, such as one or more of a caption, human pose, depth, or surface normal.

An example method may include accessing a plurality of inputs comprising first input data and second input data. The first input data may comprise a text prompt describing a desired image. The second input data may be indicative of one or more structural features of the desired image.

The method may further include generating one or more outputs via a first generative machine learning model that uses the plurality of inputs as first control signals. For example, the second input data comprises pose data that indicates one or more structural features of the desired image, with the first generative machine learning model being trained to at least partially reflect the pose data in the one or more intermediate outputs.

In some examples, one or more of the outputs of the first generative machine learning model are used as inputs to a second generative machine learning model. Outputs of the first generative machine learning model may thus be referred to herein as “intermediate outputs.”

The method may include generating an output image via the second generative machine learning model. The second generative machine learning model uses at least a subset of the plurality of inputs and at least a subset of the one or more intermediate outputs as second control signals. In some examples, the pose data comprises human pose data, the one or more structural features of the desired image comprises a pose of at least one human in the desired image, and the output image depicts the at least one human. The pose data may be provided in the form of a pose map that defines at least one body skeleton. In some examples, the second input data is generated based on a reference image that contains the one or more structural features of the desired image.

The one or more intermediate outputs may include a plurality of intermediate outputs among which the one or more structural features are spatially aligned. For example, the first generative machine learning model may generate one or more of a depth map, a surface normal map, a color image, a pose map, or an edge map. Where two or more intermediate outputs are generated, the first generative machine learning model is trained to synthesize the intermediate outputs such that they have spatially aligned structural features (e.g., human anatomy).

In some examples, the first generative machine learning model comprises a diffusion model (e.g., a latent diffusion model), and the one or more intermediate outputs comprise a plurality of intermediate outputs that are at least partially simultaneously denoised via the diffusion model. Generating the plurality of intermediate outputs may include initializing a noised state associated with each of the plurality of intermediate outputs and performing denoising by denoising the noised states conditioned on the first control signals.

The first generative machine learning model may include a set of branches, with each branch in the set of branches being configured to denoise a respective one of the plurality of intermediate outputs. For example, each branch may function as a “structural expert branch” to denoise a particular output, such as a depth map or a surface normal map conditioned on the first control signals. The first generative machine learning model may also include one or more common neural network layers that are shared across the set of branches. Accordingly, the first generative machine learning model may be referred to, at least in some implementations, as a latent structural diffusion model.

For example, the intermediate outputs may include a depth map and a surface normal map, with the first generative machine learning model being trained to generate the depth map and the surface normal map based at least partially on the pose data and the text prompt that function as first control signals. The method may then include processing at least the depth map and the surface normal map via the second generative machine learning model to generate the output image (e.g., together with the text prompt and the pose data).

In some examples, the intermediate outputs comprise a predicted color image and one or more additional intermediate outputs, and the one or more additional intermediate outputs comprise at least one of: a depth map, a surface normal map, a pose map, or an edge map. The subset of the one or more intermediate outputs may include the one or more additional intermediate outputs, with the predicted color image being excluded from the subset of the one or more intermediate outputs such that the predicted color image is not processed via the second generative machine learning model.

The second generative machine learning model may also comprise a diffusion model. The first generative machine learning model and the second generative machine learning model may comprise different types of diffusion models. In some examples, the second generative neural network is based on a Stable Diffusion model. In some examples, the second generative machine learning model is trained to perform structure-guided refinement based on one or more of the intermediate outputs. The second generative machine learning model may thus be referred to as a refiner, or, more specifically, a structure-guided refiner.

The method may include causing presentation of the output image at a user device of a user. In some examples, the method includes receiving user input comprising at least the text prompt from the user device. The output image may be caused to be presented at the user device of the user in response to receiving the user input. The user device may be a computing device of a user of an interaction system as described herein. The user device may execute an interaction application associated with the interaction system. In some examples, the user input is received via the interaction application (e.g., as part of an automatic image generation function of the interaction application).

Accordingly, a latent structural diffusion model may be provided in some examples. The latent structural diffusion model may simultaneously denoise control signals for downstream use, such as a depth map and surface normal map, along with a synthesized RGB image. The latent structural diffusion model may enforce the joint learning of image appearance, spatial relationship, and geometry in a unified network, where respective branches in the model complement each other with both structural awareness and textural richness.

In some examples, to boost visual quality, a structure-guided refiner is provided. The structure-guided refiner may be used to compose predicted conditions for more detailed generation of higher resolution. The structure-guided refiner may leverage a separate, pretrained super-resolution model. The structure-guided refiner may receive, as inputs, the control signals generated by the latent structural diffusion model (or a subset thereof).

Simultaneously denoising multiple modalities in a first stage may enable an image generation system to better capture both appearance and structure, and thus better convey user intent. Predicted signals produced in the first stage may provide conditional guidance in a second stage.

In some examples, however, the latent structural diffusion model may be utilized without the structure-guided refiner. Accordingly, even though outputs generated by the latent structural diffusion model are referred to herein as “intermediate outputs,” they may be applied as “final outputs” in some cases.

Different types of conditions or control signals may be utilized. Examples of controls (in addition to a conventional text prompt) include a pose map, a depth map, a surface normal map, and an edge map.

A pose map may be a representation of a skeletal pose (e.g., a two-dimensional (2D) pose) of one or more subjects (e.g., a human subject) in an image or desired image. It may encode the spatial configuration of key body points, such as joints, through key points and linkages connecting them, for example, in the form of a stick-figure outline. Pose maps can provide coarse structural guidance on the positioning and articulation of a human subject.

A depth map may be an image where each pixel encodes depth or distance information of that point from a camera or notional camera. It may provide detailed structural understanding of scene geometry and spatial relationship between a subject and a background or other features.

A surface normal map, or normal map, may encode the direction or orientation of surfaces in a three-dimensional (3D) scene. Pixels may store a 3D vector representing the perpendicular direction of a physical surface at that point. For example, a surface normal map contains three color channels (x, y, z components of the normal vector) at each pixel location to encode the surface orientation. Normal maps may allow modeling fine-grained geometry and shapes of objects and surfaces.

An edge map or image may extract prominent contours, silhouettes, or outlines of objects in a scene. It may transform an image into, or depict a scene as, a sketch-like representation containing major edges and shapes. Sketch edges images may provide stylistic guidance related to the geometry and form of the subject.

By modeling both appearance and multi-level structure jointly, an image generation system may generate images with improved alignment in spatial geometry and texture. This may address or alleviate technical challenges associated with generating more detailed, coherent, or natural images (e.g., human images). Benefits of techniques described herein may include one or more of:
User experience: a user may provide suitable input and receive an automatically generated image with high quality and realism. This may reduce the consumption of computing resources, for example, as the user may not have to generate multiple images before a satisfactory image is obtained. By modeling human structure in the latent space, computing resource requirements may be further reduced.
Augmented reality: in some cases, an image may be generated without explicit user input, such as a virtual clothing “try-on” scenario. An interaction application may thus provide an augmented reality experience that utilizes an output image generated using techniques described herein.
Controllable generation: by incorporating explicit pose skeletons or other structural guidance as input, body position and gestures may be better controlled during generation (e.g., when compared to providing text alone as an image).
Scalable framework: a two-stage design may allow for efficient building on top of existing diffusion models, such as Stable Diffusion.
Applicable to other domains: while examples described herein focus on human images, modeling latent structure may benefit the generation of high-fidelity images in other domains, such as other structured domains including non-human animals, furniture, and so forth.
Generation of training data: a model as described herein may be used to create large-scale synthetic datasets of high quality for downstream tasks. For example, synthetic datasets with human images can be generated and used to train more lightweight or smaller downstream models (e.g., that can easily or more easily be deployed on a mobile device).
Deployable components: components of the model or framework may be packaged into interfaces, such as Application Programming Interfaces (APIs), for easy application integration.

As mentioned, a significant technical problem in the field of automatic image generation based on text is the creation of incoherent human images, particularly when synthesizing complex human figures with accurate anatomy and natural poses. Machine learning models may struggle with maintaining structural coherence, resulting in images with disjointed body parts, unnatural poses, or features that otherwise do not accord with reality. Techniques described herein may provide a technical solution for better capturing multi-level structural correlations within human images or other images wherein relatively complex structural relationships are present. By jointly denoising different components, such as an RGB image, depth map, and surface normal map, a model can better enforce spatial alignment of elements, ensuring, for example, that generated human figures are anatomically coherent and possess natural poses. This may provide an improvement in the field of automated image generation by allowing for the generation of images with better structural integrity, quality, or realism.

Another technical problem in at least some generative models is limited control over the synthesis process. This may, for example, lead to a lack of diversity and flexibility in the generated images. By incorporating multiple control signals, such as two or more of text prompts, pose skeletons, depth maps, and surface normal maps, more granular control over the image synthesis process can be achieved to address or alleviate this technical problem. This may lead to downstream benefits, such as easier and more computationally efficient creation of large datasets with diverse images.

Examples described herein may include a two-stage generative process. For example, as mentioned elsewhere, a first stage may utilize a latent structural diffusion model to generate intermediate outputs and a second stage may utilize a structure-guided refiner to generate a final image. In two-stage generative processes, technical challenges related to error accumulation may arise. For example, imperfections in intermediate outputs can adversely affect the quality of a final image. Examples described herein address or alleviate such technical challenges through a robust conditioning scheme that includes a dropout scheme for conditions (e.g., random dropout of conditions) during training. For example, such an approach “encourages” a model to not overly rely on any single input condition, thereby enhancing its ability to generalize and produce high-quality images even when some intermediate outputs contain artifacts. This may, in turn, lead to more reliable and consistent generation of high-fidelity human images (e.g., by a structure-guided refiner as described herein).

### Networked Computing Environment

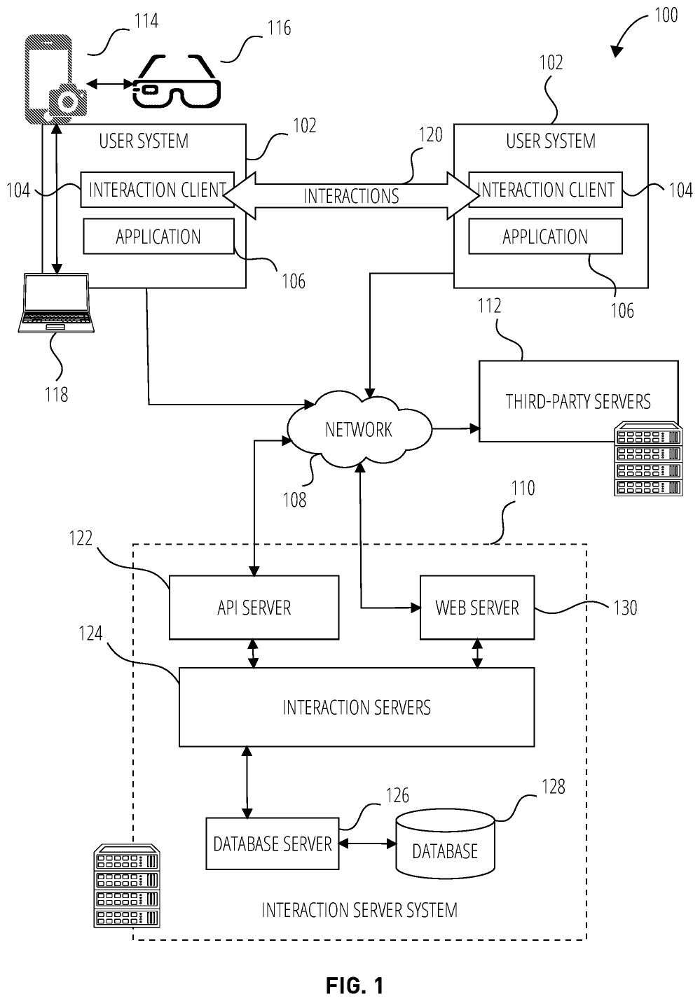

FIG. 1 is a block diagram showing an example interaction system 100 for facilitating interactions (e.g., exchanging text messages, conducting text, audio and video calls, or playing games) over a network. The interaction system 100 includes multiple user systems 102, each of which hosts multiple applications, including an interaction client 104 (as an example of an interaction application) and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112. An interaction client 104 can also communicate with locally hosted applications 106 using APIs.

Each user system 102 may include one or multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to deploy particular technology and functionality within the interaction server system 110 initially, but later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, content augmentation (e.g., filters or overlays), message content persistence conditions, entity relationship information, and live event information. Data exchanges within the interaction system 100 are invoked and controlled through functions available via user interfaces of the interaction clients 104.

Turning now specifically to the interaction server system 110, an API server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

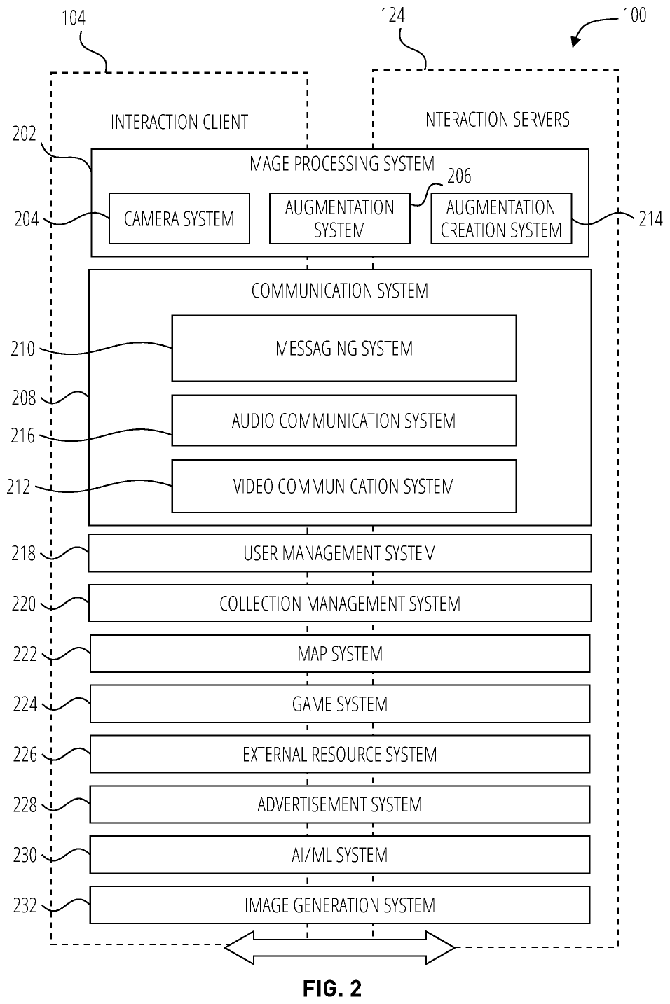

The API server 122 receives and transmits interaction data (e.g., commands and message payloads) between the interaction servers 124 and the user systems 102 (and, for example, interaction clients 104 and other applications 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the automatic generation of images (e.g., generating an image via a machine learning model executed at the interaction server system 110 based on a user text prompt); the retrieval of messages and content; the addition and deletion of entities (e.g., friends) to an entity relationship graph (e.g., the entity graph 1308); the location of friends within an entity relationship graph; and opening an application event (e.g., relating to the interaction client 104). The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of a microservice subsystem may include:
Function logic: The function logic implements the functionality of the microservice subsystem, representing a specific capability or function that the microservice provides.
API interface: Microservices may communicate with other components through well-defined APIs or interfaces, using lightweight protocols such as representational state transfer (REST) or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

The interaction system 100 may employ a monolithic architecture, a service-oriented architecture (SOA), a function-as-a-service (FaaS) architecture, or a modular architecture. Example subsystems are discussed below.

An image processing system 202 provides various functions that enable a user to capture and augment (e.g., annotate, or otherwise modify or edit) media content associated with a message. A camera system 204 includes control software (e.g., in a camera application) that interacts with and controls camera hardware (e.g., directly or via operating system controls) of the user system 102 to modify and augment real-time images captured and displayed via the interaction client 104.

An augmentation system 206 provides functions related to the generation and publishing of augmentations (e.g., filters or media overlays) for images captured in real-time by cameras of the user system 102 or retrieved from memory of the user system 102.

For example, the augmentation system 206 operatively selects, presents, and displays media overlays (e.g., an image filter or an image lens) to the interaction client 104 for the augmentation of real-time images received via the camera system 204 or stored images retrieved from memory of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of a communication system 208, such as a messaging system 210 and a video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates. In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

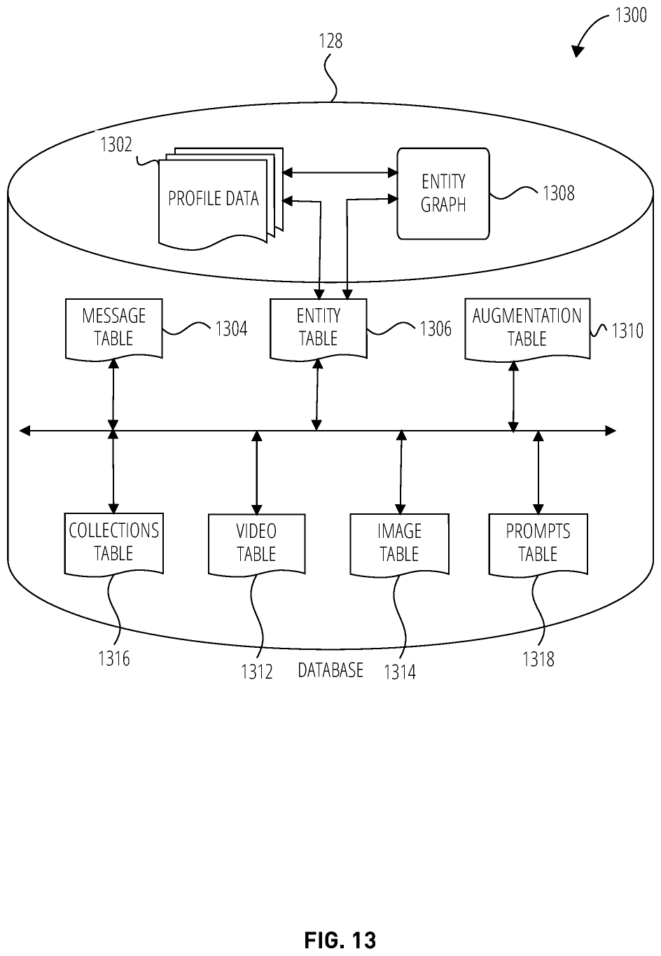

A user management system 218 is operationally responsible for the management of user data and profiles, and maintains entity information (e.g., stored in entity tables 1306, entity graphs 1308, and profile data 1302 of FIG. 13) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location functions and supports the presentation of map-based media content and messages by the interaction client 104. For example, the map system 222 enables the display of user icons or avatars (e.g., stored in profile data 1302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes APIs with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a graphical user interface of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., 2D avatars of users with or without different avatar characteristics). As another example, external resources that include small-scale versions of applications (e.g., web-based versions of applications) are provided with access to a second type of user data (e.g., payment information, 2D avatars of users, 3D avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An AI and machine learning system 230 provides a variety of services to different subsystems within the interaction system 100. For example, the AI and machine learning system 230 operates with the image processing system 202 and the camera system 204 to analyze images and extract information such as objects, text, or faces. This information can then be used by the image processing system 202 to enhance, filter, or manipulate (e.g., apply a visual augmentation to) images. The AI and machine learning system 230 may be used by the augmentation system 206 to generate augmented content and augmented reality experiences, such as adding virtual objects or animations to real-world images. The communication system 208 and messaging system 210 may use the AI and machine learning system 230 to analyze communication patterns and provide insights into how users interact with each other and provide intelligent message classification and tagging, such as categorizing messages based on sentiment or topic.

The AI and machine learning system 230 may also provide chatbot functionality to message interactions 120 between user systems 102 and between a user system 102 and the interaction server system 110. The AI and machine learning system 230 may also provide generative functionality, such as allowing a user to generate text, image, or video content based on prompts (and optionally additional inputs). The AI and machine learning system 230 may work with the audio communication system 216 to provide speech recognition and natural language processing capabilities, allowing users to interact with the interaction system 100 using voice commands.

As mentioned, the AI and machine learning system 230 may provide generative AI functionality. An image generation system 232 may receive input from a user and pass the inputs to the AI and machine learning system 230 to generate one or more images. The AI and machine learning system 230 may execute one or more machine learning models, such as one or more diffusion models, that generate images based on text prompts and/or other conditions (e.g., structural information about a desired image). In some examples, the AI and machine learning system 230 implements a latent structural diffusion model and/or a structure-guided refiner, as described herein.

The AI and machine learning system 230 and the image generation system 232 may receive user input originating from the interaction client 104 of a user system 102 of a user. The AI and machine learning system 230 and the image generation system 232 may also cause generated outputs (e.g., images) to be transmitted and presented to the user via the interaction client 104. In some examples, the image generation system 232 is also responsible for content checking or filtering, such as checking a prompt for objectionable language before allowing an image to be generated based thereon.

The image generation system 232 may work with the augmentation system 206 to provide an augmented reality experience on the interaction client 104 that utilizes AI-generated images. For example, images generated via the image generation system 232 can be utilized in a “virtual try-on” feature or an image animation feature provided on the user system 102 executing the interaction client 104.

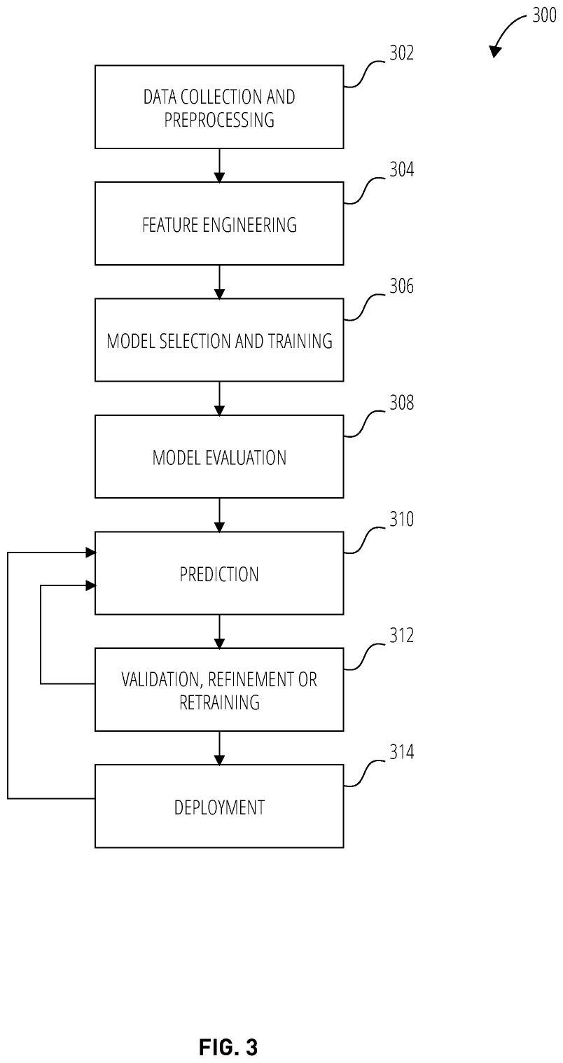

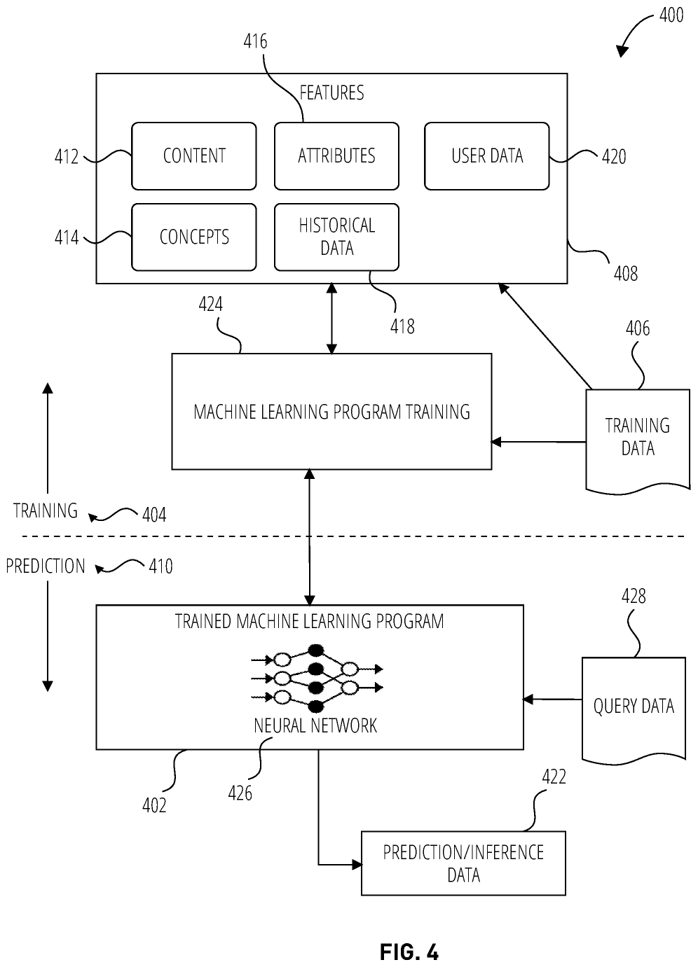

FIG. 3 is a flowchart depicting a machine learning pipeline 300, according to some examples. The machine learning pipeline 300 may be used to generate a trained model such as, for example, the trained machine learning program 402 shown in the diagram 400 of FIG. 4.

Broadly, machine learning may involve using computer algorithms to automatically learn patterns and relationships in data, potentially without the need for explicit programming. Machine learning algorithms may be divided into three main categories: supervised learning, unsupervised learning, and reinforcement learning.
Supervised learning involves training a model using labeled data to predict an output for new, unseen inputs. Examples of supervised learning algorithms may include linear regression, decision trees, and neural networks.
Unsupervised learning involves training a model on unlabeled data to find hidden patterns and relationships in the data. Examples of unsupervised learning algorithms may include clustering, principal component analysis, and generative models, such as autoencoders.
Reinforcement learning involves training a model to make decisions in a dynamic environment by receiving feedback in the form of rewards or penalties. Examples of reinforcement learning algorithms may include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is a supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms may include decision trees, k-nearest neighbors, clustering algorithms, and deep learning algorithms, such as Convolutional Neural Networks (CNNs), Recurrent Neural Networks (RNNs), and transformer models. The choice of algorithm may depend on the nature of the data, the complexity of the problem, and the performance requirements of the application.

The performance of machine learning models may be evaluated on a separate test set of data that was not used during training to ensure that the model can generalize to new, unseen data. Although several specific examples of machine learning algorithms are discussed herein, the principles discussed herein can, where possible or relevant, be applied to other machine learning algorithms as well. Deep learning algorithms such as CNNs, RNNs, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine learning program 402 may include multiple phases that form part of the machine learning pipeline 300, including, for example, the following phases illustrated in FIG. 3:
Data collection and preprocessing 302: This phase may include acquiring and cleaning data to ensure that it is suitable for use in the machine learning model. This phase may also include removing duplicates, handling missing values, and converting data into a suitable format.
Feature engineering 304: This phase may include selecting and transforming the training data 406 to create features that are useful for predicting the target variable. Feature engineering may include (1) receiving features 408 (e.g., as structured or labeled data in supervised learning) and/or (2) identifying features 408 (e.g., unstructured or unlabeled data for unsupervised learning) in training data 406.
Model selection and training 306: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 308: This phase may include evaluating the performance of a trained model (e.g., the trained machine learning program 402) on a separate testing dataset. This phase can help determine if the model is overfitting or underfitting and determine whether the model is suitable for deployment.
Prediction 310: This phase involves using a trained model (e.g., trained machine learning program 402) to generate predictions on new, unseen data.
Validation, refinement, or retraining 312: This phase may include updating a model based on feedback generated from the prediction phase, such as new data or user feedback.
Deployment 314: This phase may include integrating the trained model (e.g., the trained machine learning program 402) into a more extensive system or application, such as a web service, mobile app, or Internet of Things (IoT) device. This phase can involve setting up APIs, building a user interface, and ensuring that the model is scalable and can handle large volumes of data.

FIG. 4 illustrates further details of two example phases, namely a training phase 404 (e.g., part of model selection and training 306) and a prediction phase 410 (part of prediction 310). Prior to the training phase 404, feature engineering 304 is used to identify features 408. This may include identifying informative, discriminating, and independent features for effectively operating the trained machine learning program 402 in pattern recognition, classification, and regression. In some examples, the training data 406 includes labeled data, known for pre-identified features 408 and one or more outcomes. Each of the features 408 may be a variable or attribute, such as an individual measurable property of a process, article, system, or phenomenon represented by a data set (e.g., the training data 406). Features 408 may also be of different types, such as numeric features, strings, and graphs, and may include one or more of content 412, concepts 414, attributes 416, historical data 418, and/or user data 420, merely for example.

In training phase 404, the machine learning program may use the training data 406 to find correlations among the features 408 that affect a predicted outcome or prediction/inference data 422. With the training data 406 and the identified features 408, the trained machine learning program 402 is trained during the training phase 404 during machine learning program training 424. The machine learning program training 424 appraises values of the features 408 as they correlate to the training data 406. The result of the training is the trained machine learning program 402 (e.g., a trained or learned model).

Further, the training phase 404 may involve machine learning, in which the training data 406 is structured (e.g., labeled during preprocessing operations). The trained machine learning program 402 may implement a neural network 426 capable of performing, for example, classification or clustering operations. In other examples, the training phase 404 may involve deep learning, in which the training data 406 is unstructured, and the trained machine learning program 402 implements a deep neural network 426 that can perform both feature extraction and classification/clustering operations.

In some examples, a neural network 426 may be generated during the training phase 404, and implemented within the trained machine learning program 402. The neural network 426 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 426 may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 426 may also be one of several different types of neural networks, such as a single-layer feed-forward network, a Multilayer Perceptron (MLP), an Artificial Neural Network (ANN), a RNN, a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 404, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In the prediction phase 410, the trained machine learning program 402 uses the features 408 for analyzing query data 428 to generate inferences, outcomes, or predictions, as examples of a prediction/inference data 422. For example, during prediction phase 410, the trained machine learning program 402 generates an output. Query data 428 is provided as an input to the trained machine learning program 402, and the trained machine learning program 402 generates the prediction/inference data 422 as output, responsive to receipt of the query data 428.

In some examples, the trained machine learning program 402 may be a generative AI model. Generative AI is a term that may refer to any type of AI that can create new content. For example, generative AI can produce text, images, video, audio, code, or synthetic data. In some examples, the generated content may be similar to the original data, but not identical.

Some of the techniques that may be used in generative AI are:
CNNs: CNNs may be used for image recognition and computer vision tasks. CNNs may, for example, be designed to extract features from images by using filters or kernels that scan the input image and highlight important patterns.
RNNs: RNNs may be used for processing sequential data, such as speech, text, and time series data, for example. RNNs employ feedback loops that allow them to capture temporal dependencies and remember past inputs.
GANs: GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
VAEs: VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.
Diffusion models, as described below.

In generative AI examples, the prediction/inference data 422 may include predictions, translations, summaries, answers, media content, or combinations thereof.

A diffusion model is a type of generative machine learning model that can be used to generate images from a given input (e.g., text prompt). It is based on the concept of “diffusing” noise throughout an image to transform it gradually into a new image. A diffusion model may use a sequence of invertible transformations to transform a random noise image into a final image. During training, a diffusion model may learn sequences of transformations that can best transform random noise into desired output. A diffusion model can be fed with input data (e.g., a text describing the desired images and the corresponding output images), and the parameters of the model are adjusted iteratively to improve its ability to generate accurate or good quality images.

Once trained, in order to generate an image, the diffusion model applies the trained sequence of transformations to input to generate an output image. The model generates the image in a step-by-step manner, updating the image sequentially with additional information until the image is fully generated. In some examples, this process may be repeated to produce a set of candidate images, from which the final image is chosen based on criteria such as a likelihood score. The resulting image may be intended to represent a visual interpretation of a text prompt. As described further below, the image may also be generated based on additional “guidance,” such as structural data provided in addition to the text prompt. These elements can be referred to as “control signals.”

Generating hyperrealistic human images from user conditions or control signals and/or system-generated conditions or control signals, such as text and pose, may be useful in various applications (e.g., augmented reality experiences, such as image animation and “virtual try-on”). However, as explained elsewhere herein, text-to-image models, such as Stable Diffusion, may struggle to create human images with coherent anatomy (e.g., arms and legs, and natural poses).

Referring generally to diffusion models, these models define a forward diffusion process to gradually convert a sample x from a real data distribution p_{data}(x) into a noisy version, and learn the reverse generation process in an iterative denoising manner. During a sampling stage, the model can transform Gaussian noise of normal distribution to real samples step-by-step. A denoising network [symbol] (·) estimates the additive Gaussian noise, which is typically structured as a UNet (convolutional neural network architecture) to minimize the ensemble of mean-squared error:

$${min}_{θ} {𝔼}_{x , c , ϵ , t} [ {w}_{t} {‖ {ϵ}_{θ} ( {α}_{t} x + {σ}_{t} ϵ ; c ) - ϵ ‖}_{2}^{2} ] ,$$

where x, c˜p_{data} are the sample-condition pairs from the training distribution; ε˜N(0, I) is the ground-truth noise; t˜U[1, T] is the time-step and T is the training step number; and αₜ, σₜ, and wₜ are the terms that control the noise schedule and sample quality decided by the diffusion sampler.

A latent diffusion model performs the denoising process in a separate latent space to reduce computational cost. For example, a pre-trained VAE first encodes an image x to latent embedding z=ε(x) for diffusion model training. At the inference stage, the generated image is reconstructed through a decoder

$$\hat{x} = D ( \hat{z} ) .$$

Such design enables scaling up to broader datasets and larger model size. This allowed for advancement, for example, from an initial Stable Diffusion series to Stable Diffusion XL (SDXL) of heavier backbone on higher resolution. Latent diffusion models thus apply the diffusion process not to the raw pixel values, but instead to an encoded latent representation.

To enable structural control for image generation, a learnable branch may be introduced to modulate a pretrained diffusion model in a “plug-and-play” manner. Different variants may be trained for different control signals, such as pose maps, depth maps, and normal maps. However, feature discrepancy may occur between main and auxiliary branches, leading to inconsistency between a control signal, such as a pose map, and the generated images.

In some examples of the present disclosure, instead of incorporating one control signal, such as pose, as a condition in addition to the text prompt, or treating different control signals as independent conditions, multi-level correlation between different types of structural information may be modeled together for more coherent human image generation. To this end, a unified framework may be provided to generate, for example, “in-the-wild” human images of high realism and diverse layouts. In some examples, a large-scale human-centric dataset contains “in-the-wild” human images of high quality and diversity. The dataset has comprehensive annotations, such as coarse-level body skeletons, fine-grained depth and/or surface normal maps, and/or high-level image captions and/or attributes.

Based on such a dataset, two modules or components may be provided for hyperrealistic, controllable human image generation. In a latent structural diffusion model, a pre-trained diffusion backbone may be augmented to simultaneously denoise, for example, RGB, depth, and normal images. Appropriate network layers may be chosen to be replicated as structural expert branches, so that the latent structural diffusion model can both handle input and output of different domains, and provide spatial alignment among the denoised textures and structures.

In this way, important aspects such as image appearance, spatial relationship, and geometry may be jointly modeled within a unified network, where branches are complementary to each other. To generate monotonous depth and surface normals that have similar values in local regions, an improved noise schedule may be utilized to eliminate low-frequency information leakage. In some examples, the same time-step is sampled for each branch for better learning and feature fusion.

In a second module, the structure-guided refiner, with the spatially-aligned structure maps, it is possible to compose the predicted conditions for detailed generation of higher resolution. A robust conditioning scheme may be provided to mitigate the effect of error accumulation in this two-stage generation pipeline, as described in greater detail below.

In some examples, a latent structural diffusion model comprises a model that is extended for efficient capturing of explicit appearance and latent structure, while a structure-guided refiner is built on a pretrained model, such as SDXL (e.g., SDXL 1.0), for visual quality.

Referring now specifically to the training of a latent structural diffusion model, in some examples, given a collection of N human images x with their captions c, the depth d, surface normal n, and pose skeleton p for each sample is annotated. For example, neural networks may be used to generate depth maps, surface normal maps, and/or 2D pose maps.

A training dataset may thus be denoted as:

{xᵢ, cᵢ, dᵢ, nᵢ, pᵢ}ᵢ₌₁^{N}

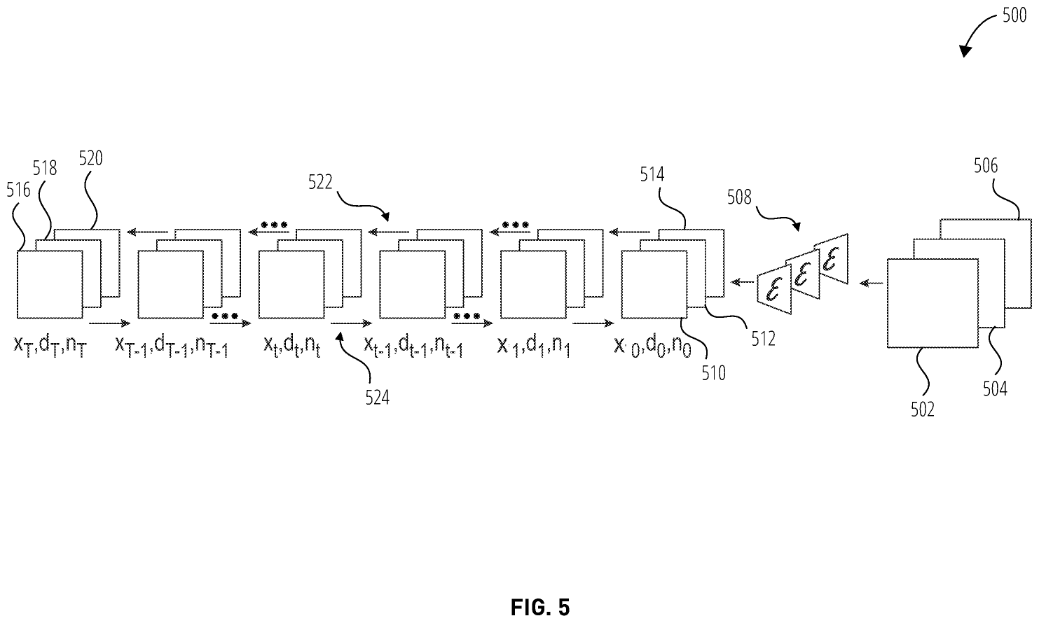

FIG. 5 is a diagram 500 that illustrates aspects of training of a latent structural diffusion model, according to some examples. The diagram 500 provides a simplified and schematic representation of the training process for a latent structural diffusion model that is designed to generate coherent and detailed images based on input conditions.

In some of the drawings or descriptions in the present disclosure, for notational simplicity, pixel-/latent-space targets are denoted with the same variable.

The process of FIG. 5 is shown to begin with an RGB image 502, a depth map 504, and a surface normal map 506. These inputs represent the initial conditions or control signals from which the latent structural diffusion model will learn to generate new images. The RGB image 502 is a color image that provides the visual appearance of the subject. The depth map 504 provides spatial information about the distance of the surfaces in the image from the viewpoint, and the surface normal map 506 encodes the angles of those surfaces relative to the same viewpoint.

An encoding operation 508 is applied to each of the inputs, resulting in an encoded RGB image 510 (x), an encoded depth map 512 (d), and an encoded surface normal map 514 (n), and allowing iterative noising 522 and iterative denoising 524 to be performed in the latent space. These encoded representations (x₀, d₀, n₀) are subjected to the iterative noising 522, which adds noise to the encoded images over a series of steps, resulting in an encoded and fully noised RGB image 516, an encoded and fully noised depth map 518, and an encoded and fully noised surface normal map 520, as shown at time point T in FIG. 5 (x_{T}, d_{T}, n_{T}). This process of iterative noising 522 is designed to simulate the diffusion process that the model will later learn to reverse.

The iterative denoising 524 is the reverse of the noising process. The model learns to progressively remove noise from the noised representations, reconstructing the original encoded RGB image 510, encoded depth map 512, and encoded surface normal map 514. Through this process, the model learns the distribution of the original representations and becomes capable of generating new representations that can be decoded to RGB images 502, depth maps 504, and surface normal maps 506 that are structurally coherent and visually similar to the training data.

In an example latent structural diffusion model (G₁), an image (e.g., RGB image) \hat{x}, depth \hat{d}, and surface normal \hat{n} are estimated, conditioned on a caption c (e.g., text prompt) and pose skeleton p (e.g., pose map).

In an example structure-guided refiner (G₂), the predicted structures of depth (\hat{d}) and surface normal (\hat{n}) serve as further guidance for the generation of higher-resolution results \hat{x}_{high-res}. Accordingly, in some examples, a training setting for the machine learning pipeline can be formulated as:

$$\hat{x} , \hat{d} , \hat{n} = {𝒢}_{1} ( c , p ) , {\hat{x}}^{high - res} = {𝒢}_{2} ( c , p , \hat{d} , \hat{n} )$$

It will, however, be appreciated that these are non-limiting examples and that control signals may be adjusted, e.g., to accommodate a particular use case.

During inference, in some examples, only a text prompt and body skeleton (e.g., 2D pose input) are needed to synthesize well-aligned RGB, depth, and surface normal images. It is noted that depth and surface normal conditions for the structure-guided refiner (G₂) may be adjusted, enabling more flexible and controllable generation.

To incorporate body skeletons for pose control, feature residual or input concatenation may be used. However, some problems may remain. Firstly, sparse key points may only depict the coarse human structure, while the fine-grained geometry and foreground-background relationship are ignored. Secondly, the RGB image and structure representations are spatially aligned but substantially different in latent space. Jointly modeling them remains challenging. Thirdly, in contrast to colorful RGB images, the structure maps are mostly monotonous with similar values in local regions, which are hard to learn by diffusion models. In some examples, these problems are addressed or alleviated by a unified model for simultaneous denoising of depth and surface normal along with a synthesized RGB image.

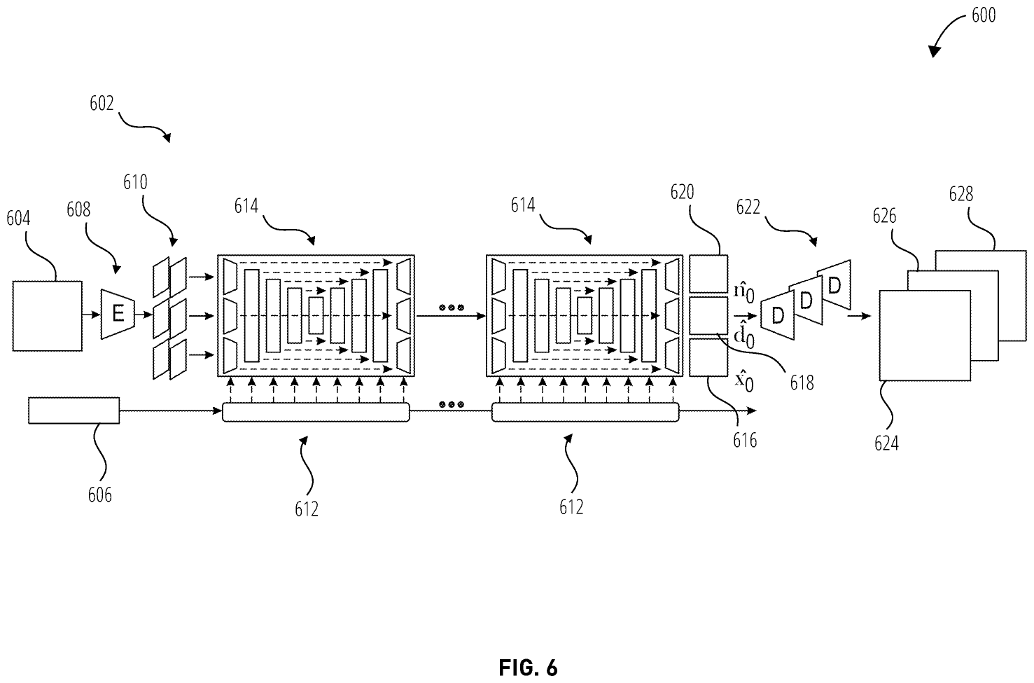

FIG. 6 is a diagram 600 that illustrates generation of a predicted RGB image 624, a predicted depth map 626, and a predicted surface normal map 628 by a first generative machine learning model in the example form of a latent structural diffusion model 602. The latent structural diffusion model 602 commences its operation by receiving a pose map 604 and a text prompt 606 as inputs. The pose map 604 provides a structural outline of, for example, a human figure's posture, while the text prompt 606 offers descriptive context or thematic information.

The latent structural diffusion model 602 may serve as a foundational stage where the transformation of input data begins. Through an encoding operation 608, the pose map 604 is converted into a latent representation that encapsulates the spatial information in a form that is amenable to the model's internal mechanisms. In order to align the pose conditions with the latent embeddings associated with an encoded RGB image 616, an encoded depth map 618, and an encoded surface normal map 620, respectively, the pose map 604 may be processed with an encoder (e.g., a VAE) and directly concatenated with the noisy latent embeddings as illustrated by concatenation operation 610 in FIG. 6. The text prompt 606 may be added with attention in blocks or layers of the latent structural diffusion model 602, together with time embeddings, as illustrated by cross-attention and time embedding application 612. The text prompt 606 may be encoded, for example, with a Vision Transformer (ViT).

The latent structural diffusion model 602 performs joint denoising with expert branches 614. Specifically, in the case of FIG. 6, the latent structural diffusion model 602 employs specialized branches to refine the latent representations corresponding to encoded RGB image 616, the encoded depth map 618, and the encoded surface normal map 620, respectively. This simultaneous denoising may ensure that the generated outputs are not only visually coherent, but also maintain structural and spatial integrity.

Following denoising, the encoded RGB image 616, encoded depth map 618, and encoded surface normal map 620 are subjected to decoding operations 622. These operations are tasked with transforming the latent representations into their respective visual formats. The decoding of the encoded RGB image 616 culminates in the creation of the predicted RGB image 624, which visually embodies the attributes specified by the text prompt 606 and adheres to the structural guidance provided by the pose map 604. The decoding operations 622 also yield the predicted depth map 626 and the predicted surface normal map 628. The predicted depth map 626 offers a detailed representation of the scene's geometry by indicating the distance of objects from the viewpoint, while the predicted surface normal map 628 reveals the orientation of surfaces within the image. Together, these maps complement the predicted RGB image 624, providing a rich and detailed depiction of the scene that aligns with the initial inputs (e.g., control signals) of the pose map 604 and the text prompt 606.

Depth and surface normal information may be chosen as additional learning targets for two reasons: 1) depth and normal can be relatively easily annotated for large-scale datasets, and 2) as two commonly-used forms of structural guidance, they may complement or enhance spatial relationship and geometry information. However, these are non-limiting examples, and other control signals (e.g., an image outline/edge map) may be used in other examples.

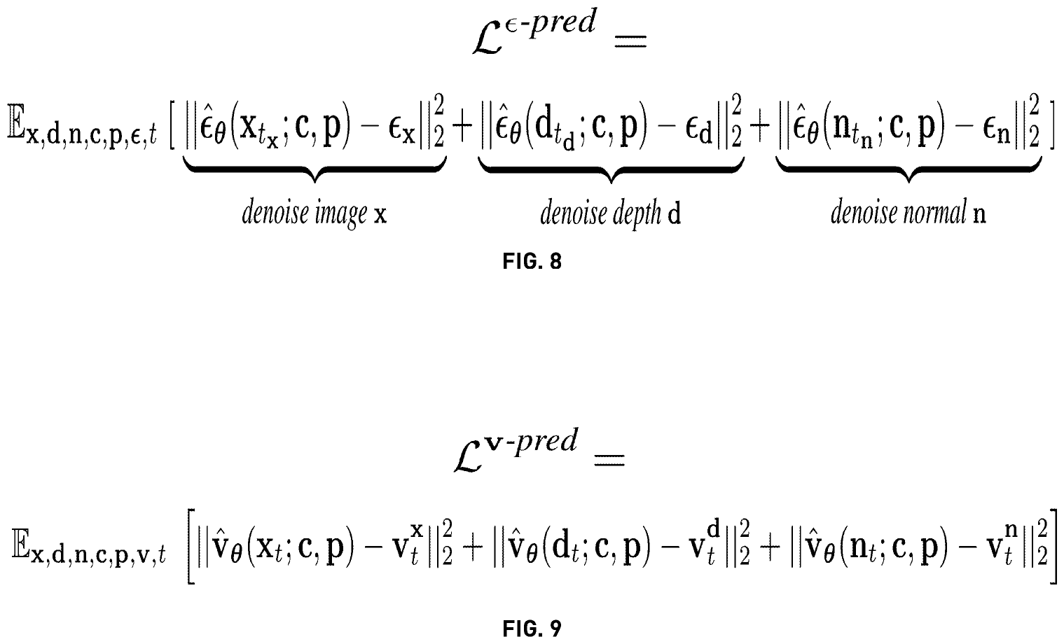

A naive method may be to train three separate networks to denoise the RGB, depth, and normal individually. However, spatial alignment between them is hard to preserve. Therefore, in some examples, the joint distribution is captured in a unified model by simultaneous denoising, which can be trained with the simplified objective shown in FIG. 8. In FIG. 8, ϵₓ, ϵ_{d}, and ϵₙ˜N(0, I) are three independently sampled Gaussian noise (shortened as ϵ) for the RGB, depth, and normal, respectively. Further, the noised feature maps of three learning targets are, respectively:

$${x}_{{t}_{x}} = {α}_{{t}_{x}} x + {σ}_{{t}_{x}} {ϵ}_{x}$$

$${d}_{{t}_{d}} = {α}_{{t}_{d}} d + {σ}_{{t}_{d}} {ϵ}_{d}$$

$${n}_{{t}_{n}} = {α}_{{t}_{n}} n + {σ}_{{t}_{n}} {ϵ}_{n}$$

Further, tₓ, t_{d}, and tₙ˜U[1, T] are the sampled time-steps that control the scale of added Gaussian noise. By optimizing this combined objective function, the model learns to denoise all three target outputs, namely the RGB image, depth image, and normal map, in a unified framework.

Structural expert branches with a shared (or partially shared) backbone are provided in some examples. A UNet of the latent structural diffusion model 602 may contain down-sample blocks or layers (DownBlocks), middle blocks or layers, and up-sample blocks or layers (UpBlocks), which are interleaved with convolution and self-attention or cross-attention layers. In particular, in some examples, the DownBlocks (e.g., components present in the encoder portion of the UNet to compress input into lower resolution space, which components may each include multiple layers) compress input noisy latent to the hidden states of lower resolution, while the UpBlocks (e.g., components present in the decoder portion of the UNet to take features back up to higher resolution space, which components may each include multiple layers) conversely upscale intermediate features to the predicted noise.

As mentioned, the latent structural diffusion model 602 may include one or more common neural network layers or blocks that are shared across the set of expert branches. In some examples, the first one or several DownBlocks and the last one or several UpBlocks for each branch, which are the most neighboring layers to the input and output, may be replicated. In this way, each branch gradually maps input noisy latent of different domains to similar distribution for feature fusion. Then, after a series of shared modules, blocks, or layers, the same feature is distributed to each expert branch to output noises (e.g., ϵₓ, ϵ_{d}, and ϵₙ) for spatially-aligned results.

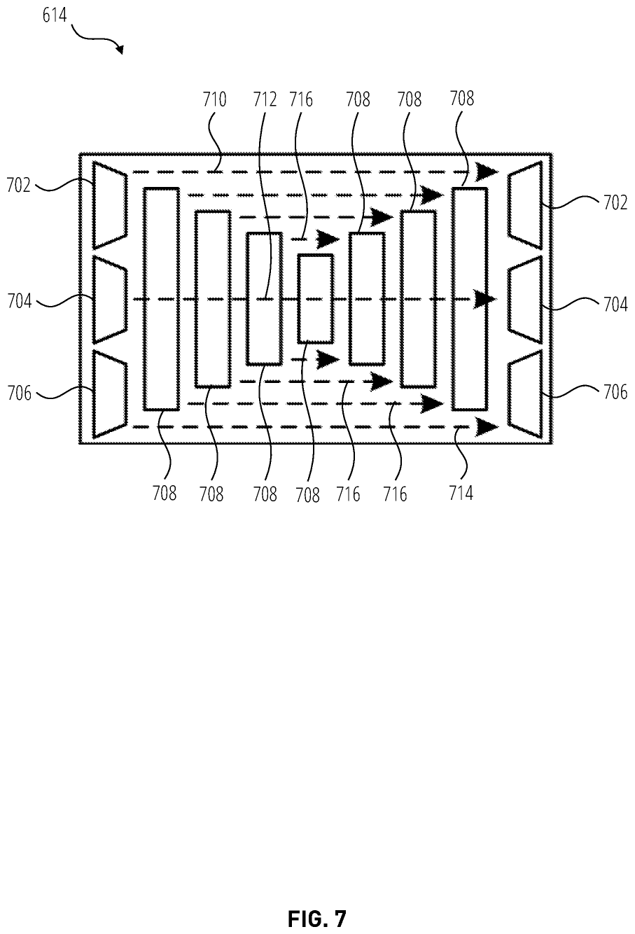

FIG. 7 diagrammatically illustrates expert branches, shared layers, and connections within latent structural diffusion model 602 of FIG. 6, according to some examples. Specifically, FIG. 7 illustrates more detail around the joint denoising with expert branches 614 illustrated in FIG. 6.

In the case of FIG. 6 and FIG. 7, the latent structural diffusion model 602 includes three expert branches: a surface normal expert branch 702, a depth expert branch 704, and an RGB expert branch 706. Each of these branches specializes in processing and refining one aspect of the image data: surface normals, depth information, and RGB color channels, respectively. These branches are designed to work in parallel or partially in parallel, applying their specialized knowledge to their respective data streams. It will be appreciated that other examples may include other and/or additional expert branches, depending on the selected conditions.

The latent structural diffusion model 602 further includes shared UNet blocks 708. The shared UNet blocks 708 represent a series of neural network layers that are common to all three branches. These shared blocks facilitate the integration of information across the different modalities of data. By processing the data through these shared layers, the latent structural diffusion model 602 ensures that the features learned for one aspect of the image can inform and enhance the processing of the others, leading to a more cohesive and harmonious synthesis of the final image.

Each expert branch is equipped with skip connections, such as the skip connection 710 of the surface normal expert branch 702, the skip connection 712 of the depth expert branch 704, and the skip connection 714 of the depth expert branch 704 as illustrated in FIG. 7. These connections allow for direct transfer of certain information to deeper layers within the network, bypassing certain intermediate layers. This mechanism may help to preserve high-resolution details that might otherwise be lost during processing. Skip connections also exist between certain shared UNet blocks 708, as indicated by the skip connections 716 in FIG. 7. These connections may further support the preservation and integration of spatial and feature information throughout the network, contributing to the generation of images that are both detailed and consistent with the input conditions.

It is noted that the number of shared modules, blocks, or layers may present a trade-off between spatial alignment and better distribution learning. On the one hand, more shared layers may guarantee more similar features in the final output, leading to the paired texture and structure corresponding to the same image. On the other hand, the RGB, depth, and normal information may be treated as different views of the same image, where predicting them from the same feature resembles an image-to-image translation task.

In some examples, the design of the latent structural diffusion model 602 replicates the conv_in (input convolutional component), first DownBlock, last UpBlock, and conv_out (output convolutional component) for each structural expert branch 702, 704, 706, where the skip-connections are maintained for each branch separately, as shown in FIG. 7. Accordingly, first and last layers or sets of layers are replicated among the branches 702, 704, 706, while middle layers are shared between the branches. This may yield both aligned results and joint capture of image appearance, spatial relationship, and geometry. It is noted that the design is not limited to three targets. It is possible to generalize to arbitrary paired distributions by involving more branches.

In some cases, a problem may arise with the distribution of depth and surface normal. For example, after annotation by off-the-shelf estimators, they are regularized to a certain data range with similar values in local regions, such as [0, 1] for depth and unit vector for surface normal. Such monotonous images may leak low-frequency signals, such as the mean of each channel during training. Also, their latent distributions may be divergent from that of the RGB space, making it difficult to exploit common noise schedules and diffusion. To address this, in some examples, the depth and normal latent features may be normalized to the same distribution of RGB latent, so that the pre-trained denoising knowledge can be easily adapted. The zero terminal signal-to-noise ratio (SNR) (α_{T}=0, σ_{T}=1) may further be enforced to eliminate a structure map's low-frequency information.

A further item to address may be how to sample time-step t for each branch. One option may be to perturb the data of different modalities with different levels, which samples different t for each target, as is the case in the example equation of FIG. 8. However, in some examples, as the aim is to jointly model RGB, depth, and normal, this strategy may only give a 10⁻⁹ probability to sample each perturbation situation (given total steps T=1000), which may be too sparse to obtain suitable results. In contrast, in some examples, dense sampling can be done with the same time-step t for all the targets, so that the sampling sparsity and learning difficulty will not increase even when more modalities are learned. With the same noise level for each structural expert branch, intermediate features may follow a similar distribution when they fuse in the shared backbone, which may better complement each other.

A v-prediction learning target as shown in FIG. 9 may be utilized for better performance, in some examples. The v-prediction learning target at time-step t for RGB (x), depth (d), and normal (n), respectively, may be as follows:

$${v}_{t}^{x} = {α}_{t} {ϵ}_{x} - {σ}_{t} x , {v}_{t}^{d} = {α}_{t} {ϵ}_{d} - {σ}_{t} d , and {v}_{t}^{n} = {α}_{t} {ϵ}_{n} - {σ}_{t} n$$

In some examples, a unified simultaneous denoising network A with the structural expert branches as described above, accompanied by an improved noise schedule and time-step sampling strategy, provides a first stage implemented by the latent structural diffusion model 602 (G₁). A second stage may be implemented by a refiner model, which takes, as inputs, at least a subset of the inputs to the latent structural diffusion model 602 and at least a subset of the outputs of the latent structural diffusion model 602 (e.g., the intermediate outputs produced by the latent structural diffusion model 602).

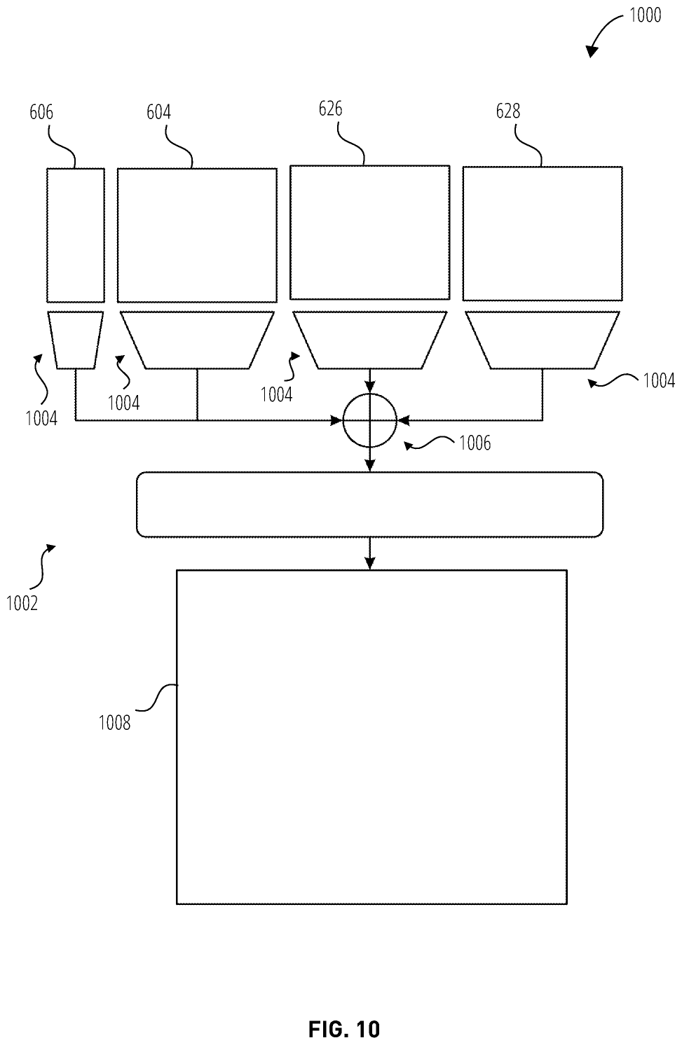

FIG. 10 is a diagram 1000 that illustrates the generation of an output image 1008 by a second generative machine learning model in the example form of a structure-guided refiner 1002. The output image 1008 is generated using, as control signals, the following inputs: the text prompt 606 and the pose map 604 (that were also utilized by the latent structural diffusion model 602 as inputs), the predicted depth map 626, and the predicted surface normal map 628. In the case of FIG. 10, the structure-guided refiner 1002 thus does not process the predicted RGB image 624 generated by the latent structural diffusion model 602.

Encoding operations 1004 are performed to generate embeddings of the text prompt 606, the pose map 604, the predicted depth map 626, and the predicted surface normal map 628, respectively. Some or all of the embeddings may be combined in an embedding combination operation 1006 to obtain a combined embedding or aggregated embedding for input to the structure-guided refiner 1002. However, it will be appreciated that certain embeddings may be utilized in other ways. For example, the text prompt 606 may be encoded and applied separately to one or more layers of the structure-guided refiner 1002 instead of including the encoded version of the text prompt 606 in the embedding combination operation 1006.

The predicted depth map 626 and the predicted surface normal map 628, which contain geometric information about the desired image, add structure and three-dimensionality, informing structure-guided refiner 1002 about spatial relationships and orientations of surfaces within the scene. The structure-guided refiner 1002 takes the one or more input embeddings and refines the data to produce (once decoded) the output image 1008. The structure-guided refiner 1002 is thus designed to leverage the structural information encoded in depth and surface normal maps, as well as a pose map, to guide the refinement process, ensuring that the output image not only matches the descriptive content of the text prompt but also adheres to certain structural requirements or constraints.

In some examples, to implement the structure-guided refiner 1002, a refiner network can then be trained to render the high-quality image \hat{x}_{high-res} by composing multi-conditions of caption c (e.g, text prompt), pose skeleton p (e.g., pose map), predicted depth \hat{d}, and predicted surface normal \hat{n}. The predicted depth and the predicted surface normal can thus be regarded as intermediate outputs produced by the latent structural diffusion model 602.

Multiple control signals may be unified at the training phase. Specifically, in some examples, each condition (control signal) is projected from input image size (e.g., 1024×1024) to a feature space vector that matches the size required by the structure-guided refiner 1002, such as an SDXL that uses 128×128. For example, each condition is encoded via a light-weight embedder of four stacked convolutional layers with 4×4 kernels, 2×2 strides, and ReLU (Rectified Linear Unit) activation. Where SDXL is used, the embeddings from each branch may be summed up coordinate-wise and further fed into a trainable copy of “SDXL Encoder Blocks.” Since involving more conditions may only incur negligible computational overhead of a tiny encoder network, the technique may be trivially extended to new structural conditions.

Since the predicted depth and surface normal conditions from the latent structural diffusion model 602 (G₁) may contain artifacts, a potential issue for such a two-stage pipeline is error accumulation, which may lead to a train-test performance gap. To address or alleviate this, inputs (e.g., structural maps or other inputs) may be dropped out for robust conditioning. Training of a structure-guided refiner may thus involve implementing a dropout scheme on one or more of the inputs to the structure-guided refiner. For example, the technique may involve randomly masking out control signals, such as replacing a text prompt with an empty string, or substituting the structural maps with zero-value images. In this way, the structure-guided refiner 1002 may learn not to solely rely on a single condition for synthesis, thus facilitating a more robust framework.

Turning now again to datasets that can be used in examples described herein, in some cases, a large dataset is important for image generation training. Where human images are to be generated, existing human-centric collections may have issues, such as low resolution, poor quality, noise, limited scale, or limited diversity. Furthermore, existing datasets may not contain rich annotations (e.g., they may only label one aspect of each image).

In some examples, a rich dataset may be created using comprehensive annotations, such as human pose, depth, and surface normal. The dataset may be created using one or more of the following approaches:
Dataset Preprocessing: human images may be isolated from multiple datasets. For example, detection techniques for detecting humans (e.g., YOLOS) can be used. For example, only those images containing 1 to 3 human bounding boxes are retained, where a human should be visible with an area ratio exceeding 10%. Samples with poor aesthetics or low resolution (e.g., <200×200) may also be removed. The dataset may encompass a wide spectrum of images, including various backgrounds and partial human regions such as clothing and limbs.
2D Human Key Points of Whole-Body, Body, Hand, or Face: In some examples, 2D human skeletons may be obtained. A 2D human skeleton image is a flexible and obtainable coarse-level condition signal. To achieve accurate key point annotations, techniques such as MMPose or ViTPose-H may be used for pose estimation. In some examples, the per-instance bounding box, key point coordinates and confidence are labeled, including, for example, a whole-body skeleton (e.g., 133 key points), body skeleton (e.g., 17 key points), hand (e.g., 21 key points), and/or facial landmarks (e.g., 68 key points).
Depth and/or Surface Normal Maps: These are fine-grained structures that reflect the geometry and spatial characteristics of images. These types of maps are commonly generated and thus obtainable.
Outpainting for Better Annotations. Diffusion models often show promising results on image inpainting and outpainting, where the appearance and structure of unseen regions can be “hallucinated” based on the visible parts. Accordingly, in some examples, it may be desirable to outpaint each image for a more holistic view given that most off-the-shelf structure estimators are trained on the “complete” views. Although the outpainted region may be imperfect with artifacts, it may complement the overall human structure.

In one example, a training dataset of approximately 340 million images was obtained using approaches as described above, and used for training. In some examples, different datasets may be used to train the latent structural diffusion model 602 and the structure-guided refiner 1002, respectively.

In some examples, the RGB, depth, and normal data may be resized and random-cropped to the target resolution of each stage. To enforce the model with size and location awareness, the original image height or width and crop coordinates may be embedded in a similar way to time embedding. For the latent structural diffusion model, a UNet from a pretrained Stable Diffusion model may be fine-tuned to v-prediction as described above, such as in 512×512 resolution. A DDIMScheduler with improved noise schedule may be used for both training and sampling. In one example, the model was trained on 128 80G NVIDIA™ A100 GPUs in a batch size of 2,048 for one week.

In some examples, for the structure-guided refiner, a SDXL model may be used as a frozen backbone and fine-tuned to ϵ-prediction, as described above, for high-resolution synthesis of 1024×1024 resolution. In one example, the model was trained on 256 80G NVIDIA™ A100 GPUs in a batch size of 2,048 for one week. The overall framework is optimized, for example, using AdamW in 1e⁻⁵ learning rate, and 0.01 weight decay.

In one specific and non-limiting example, the two-stage training process may thus be briefly summarized as follows:

Stage 1: Train the latent structural diffusion model
Inputs: caption and 2D pose
Outputs: RGB image, depth map, and surface normal map
Loss functions on RGB image, depth map, and surface normal map

Stage 2: Train the structure-guided refiner
Inputs: caption, 2D pose, depth map, and surface normal
Output: high-resolution RGB image (e.g., higher than the resolution of the latent structural diffusion model)
Loss function on high-resolution RGB image

Table 1 below illustrates implementation details for an image generation system that includes a latent structural diffusion model and a structure-guided refiner, according to some examples. The details include model architecture and training hyperparameters that may be used in some examples. It is noted that these details are included as non-limiting examples.

TABLE 1
Examples of parameters and model architecture details

| | Latent structural | Structure- |
|---|---|---|
| Parameter/Architecture | diffusion model | guided refiner |
| Activation Function | Sigmoid Linear Unit | SiLU |
| | (SiLU) | |
| Additional Embedding Type | Time | Text and time |
| Number of Heads in | 64 | 64 |
| Additional Embedding | | |
| Additional Time Embedding | 256 | 256 |
| Dimension | | |
| Attention Head Dimension | [5, 10, 20, 20] | [5, 10, 20] |
| Block Out Channels | [320, 640, | [320, 640, 1280] |
| | 1280, 1280] | |
| Cross-Attention Dimension | 1024 | 2048 |
| DownBlock Types | [“CrossAttn” × 3, | [“ResBlock” × 1, |
| | “ResBlock” × 1] | “CrossAttn” × 2] |
| Input Channel | 8 | 4 |
| Number of Input Heads | 3 | 3 |
| Condition Embedder Channels | — | [16, 32, 96, 256] |
| Transformer Layers per Block | [1, 1, 1, 1] | [1, 2, 10] |
| Layers per Block | [2, 2, 2, 2] | [2, 2, 2] |
| Input Class Embedding | — | 2816 |
| Dimension | | |
| Sampler Training Step T | 1000 | 1000 |
| Learning Rate | 1e⁻⁵ | 1e⁻⁵ |
| Weight Decay | 0.01 | 0.01 |
| Warmup Steps | 0 | 0 |
| AdamW Betas | (0.9, 0.999) | (0.9, 0.999) |
| Batch Size | 2048 | 2048 |
| Condition Dropout | 15% | 50% |
| Text Encoder | OpenCLIP ViT-H | CLIP ViT-L & |
| | | OpenCLIP |
| | | ViT-bigG |
| Pretrained Model | Stable Diffusion | SDXL-1.0-base |
| | (SD)-2.0-base | |

Performance of an image generation system that utilizes the latent structural diffusion model and the structure-guided refiner with details as shown in Table 1 was evaluated. To evaluate performance of example outputs, the following commonly known metrics were used:
Image Quality: FID (Fréchet Inception Distance), KID (Kernel Inception Distance), and FID_{CLIP} were used to reflect quality and diversity.
Text-Image Alignment: CLIP (Contrastive Language-Image Pretraining) similarity between text and image embeddings.
Pose Accuracy: A pose estimator was used to extract poses from synthetic images and compare them with the input pose conditions. Average Precision (AP) and Average Recall (AR) were adopted to evaluate the pose alignment. Note that due to noisy pose estimation, AP_{clean} and AR_{clean} were used to only evaluate on the three most salient persons.

For a comprehensive evaluation, comparisons were divided into two settings:
1. Quantitative evaluations: all methods were tested on the same benchmark, using the same prompt with DDIM Scheduler for 50 denoising steps to generate the same resolution images of 512×512.
2. Qualitative analysis: high-resolution 1024×1024 results were generated for each model with the officially provided best configurations, such as the prompt engineering, noise scheduler, and classifier-free guidance (CFG) scale.

Common practices in text-to-image generation were used to filter out a human subset for zero-shot evaluation. Images with clearly visible humans were obtained for evaluation.

Comparisons were made with generative text-to-image models, such as Stable Diffusion and SDXL, as well as with controllable methods with pose conditioning, such as ControlNet. A default CFG scale of 7.5 was used, which typically balances the quality and diversity with appealing results. The image generation system was found to outperform previous works, achieving good results on image quality and pose accuracy metrics. The image generation system also obtained satisfactory CLIP scores, particularly against baselines that have similar text encoder parameters. Overall, the image generation system showed a good balance between image quality and text alignment.

Tests were also performed to investigate whether latent structural diffusion helps with image generation, as well as how many layers to replicate in the expert branches. The following scenarios were evaluated:
1. “Denoise RGB,” which only learns to denoise an image.
2. “Denoise RGB and Depth,” which also predicts depth.
3. “Half DownBlock and UpBlock:” Half of the first DownBlock and the last UpBlock were replicated.
4. “Two DownBlocks and UpBlocks:” The first two DownBlocks and the last two UpBlocks were copied.

The results indicated that joint learning of image appearance, spatial relationship, and geometry may be beneficial. It was also found that while fewer duplicate layers may give more spatially aligned results, the per-branch parameters may be insufficient to capture distributions of each modality. In contrast, excessive duplicate layers may lead to less feature fusion across different targets.

Turning now to noise schedules, ablation was conducted on two settings:
1. Default SNR with ϵ-pred, where the original noise sampler schedules with ϵ-prediction was used.
2. Different time-steps t, where different noise levels (tₓ, t_{d}, and tₙ) were sampled for each modality.

It was found that zero-terminal SNR may be important for learning of monotonous structural maps. Further, sampling different time-steps may harm performance with more sparse training and harder information sharing.

The following scenarios were also tested with respect to the structure-guided refiner:
1. “Without random dropout,” where input conditions are not dropped out or masked out during the conditional training stage described above.
2. “Only text,” where no structural prediction is input to the model and only the text prompt is input.
3. “Condition on p,” where only human pose skeleton p was used as input condition to the refiner network.
4. “Condition on d,” where a depth map d was used as input condition.
5. “Condition on n,” that uses surface normal n as input condition.
6. Combinations of p, d, and n were also tested to verify or assess the impact of each condition on fine-grained generation.

The results indicated that, in at least some examples, a random dropout conditioning scheme may help to provide robust training with better image quality. Further, the results indicated that structural maps or guidance that contain geometry and spatial relationship information may be beneficial to image generation of higher quality. The results further suggested that surface normal data conveys rich structural information that may, at least to some degree, cover coarse-level skeleton and depth map data (except, for example, for key-point location and foreground-background relationship, in at least some examples).

To validate robustness to the impact of random seeds, inference was performed with the same input conditions (e.g., text prompt and pose skeleton) with different random seeds for generation. The results suggested that a framework as described herein may be sufficiently robust in generating high-quality and text-aligned human images.

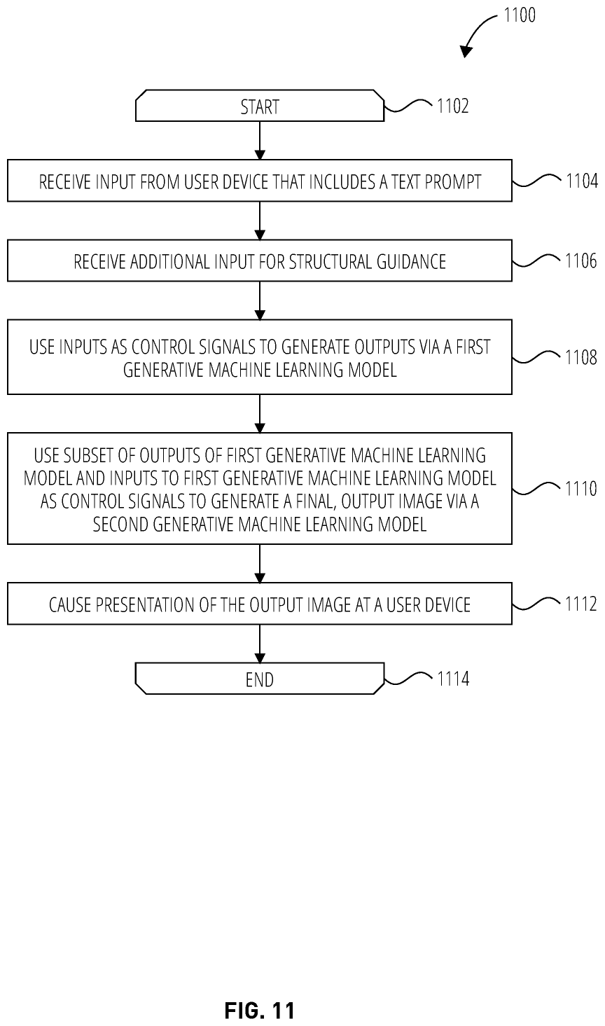

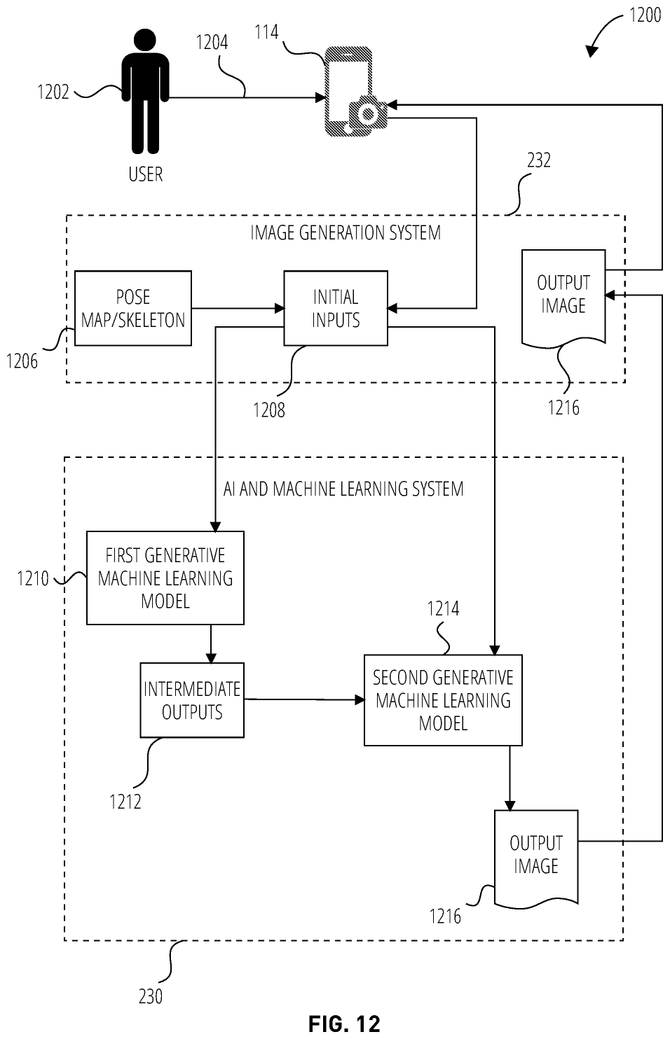

FIG. 11 is a flowchart illustrating a method 1100 for generating an image, according to some examples. Merely by way of example and not limitation, the method 1100 is executed by or using components and/or systems shown in FIG. 1 and FIG. 2. The method 1100 is further illustrated by a diagram 1200 shown in FIG. 12, that illustrates a user 1202 of the mobile device 114 of FIG. 1, as well as the image generation system 232 and the AI and machine learning system 230 of FIG. 2. However, it will be appreciated that other components, systems, or frameworks may be utilized.

In FIG. 11 and FIG. 12, a two-stage framework is utilized for high-quality human image generation. However, similar systems, components and techniques may be utilized to generate other types of images (such as images depicting non-human animals). A first stage utilizes a first generative machine learning model 1210 as shown in FIG. 12, and a second stage utilizes a second generative machine learning model 1214 as also shown in FIG. 12. In some examples, the first generative machine learning model 1210 is a latent structural diffusion model, such as the latent structural diffusion model 602 of FIG. 6. In some examples, the second generative machine learning model 1214 is a refiner model, such as the structure-guided refiner 1002 of FIG. 10.

The method 1100 commences at opening loop element 1102 and proceeds to operation 1104, where a user device transmits a text prompt to the image generation system 232 of the interaction system 100. As shown in FIG. 12, the user device may be the mobile device 114 of FIG. 1. For example, the mobile device 114 may execute an interaction client 104 that transmits the prompt in user input 1204 to the image generation system 232. The interaction client 104 may provide a user interface that enables the user 1202 to enter a prompt. Example prompts for human image generation are listed below:
“A man wearing a helmet is sitting on his blue motorcycle.”
“A man sitting down with a brown teddy bear on his shoulders.”
“Two women holding surfboards while smiling at the camera.”
“A person standing on a snowboard with knees bent and arms out on the snow with trees and snowy hills in the background.”
“A little girl posing for the camera with an adult-sized striped tie on.”

The image generation system 232 receives the user input 1204 that includes the text prompt. Identifying the prompt may include receiving a question or request from the user 1202 via text or speech. The interaction client 104 may identify keywords from the prompt and apply weights to each of the identified keywords. Accordingly, the text prompt from the user 1202 may be preprocessed instead of being fed to the first generative machine learning model 1210 directly.

In some examples, the interaction client 104 generates the prompt for selection by the user 1202 automatically based on an intent identified from real-time interaction data captured by the interaction client 104. For example, the interaction client 104 generates suggested prompts for a user based on past activity, interests, and behavior patterns. The interaction client 104 may generate personalized prompts related to topics the user may find appealing, such as if a user frequently interacts with a certain type of content about technology.

In some examples, the interaction client 104 uses popular or trending topics from the platform or the wider internet to create prompts that are likely to be of interest to a broad audience. In some examples, the interaction client 104 can generate prompts that are relevant to a certain area, such as events, news, or cultural topics. In some examples, the interaction client 104 can create prompts based on the time of day, season, or upcoming events or holidays, such as events that are time-sensitive. In some examples, based on the activity of the user 1202 within a specific application or AR experience, the interaction client 104 can generate prompts related to that context.

In some examples, by utilizing sensors and data from the mobile device 114 or another user system 102 (such as the head-wearable apparatus 116), the interaction client 104 creates context-aware prompts based on a physical environment. In some examples, the interaction client 104 can generate prompts based on real-time events occurring within the application or augmented reality experience, such as a live-streamed event. In some examples, the real-time interaction data includes a current camera feed from a camera system of the mobile device 114.

In some examples, prior to feeding the text prompt to the AI and machine learning system 230, the image generation system 232 may analyze the text prompt to check for objectionable text objects or objectionable meaning/context. The image generation system 232 may be configured to check for specific words or phrases that are not allowable, or may implement a machine learning model (e.g., together with the AI and machine learning system 230) that is trained to predict whether the text prompt may include objectionable content, or may lead to objectionable visual output (e.g., based on a predicted meaning or context of the relevant words). In some examples, the image generation system 232 automatically scans an incoming prompt using both machine learning techniques, for example, to predict a meaning or content, and rule-based checks, for example, to check for specific words that are not allowed to be in a prompt.

At operation 1106, the image generation system 232 receives or accesses additional input that serves as structural guidance in the image generation process. For example, and referring to FIG. 12, the text prompt contained in the user input 1204 may be used as a first input control signal, and a pose map, such as the pose map/skeleton 1206 shown in FIG. 12, may be used as a second input control signal. The text prompt and the pose map may thus serve as initial inputs 1208.

A pose map may be generated in various ways, such as based on user input received via the user interface of the interaction client 104 (e.g., allowing the user to draw a “skeleton”), or by way of a neural network that analyzes a reference image to generate the pose map. For example, where the interaction client 104 provides “virtual try-on” functionality for clothing, the interaction client 104 or the AI and machine learning system 230 may use an image of the user 1202 as a reference image and generate a 2D pose map to guide automatic image generation. The pose map may thus be a human pose map that shows the “skeleton” or similar features of one or more humans to be generated in a desired image.

Therefore, in some examples, in addition to a text prompt or caption, the image generation system 232 obtains or generates further data indicative of one or more structural features of a desired image. Pose data is a non-limiting example of such structural guidance information. For example, an edge map could be provided in addition to, or as an alternative to, a body skeleton.

The image generation system 232 then provides the initial inputs 1208 to the AI and machine learning system 230. At operation 1108, the AI and machine learning system 230 uses the first generative machine learning model 1210 to generate first outputs. Where the first generative machine learning model 1210 is a latent structural diffusion model, such as the latent structural diffusion model 602, the first generative machine learning model 1210 may use a first neural network that jointly denoises and generates a color (e.g., RGB, such as a low resolution RGB image) image and other outputs in the form of a depth map and surface normal map. In some examples, the first generative machine learning model 1210 does not generate the color image and only generates the depth map and/or surface normal map. The first generative machine learning model 1210 takes a prompt (e.g., text caption) and body pose information as inputs and thus generates its outputs conditioned thereon.

The outputs generated by the first generative machine learning model 1210 are spatially aligned, or substantially aligned. For example, the first generative machine learning model 1210 generates a depth map and a surface normal map that have corresponding structural features, such as corresponding positioning, angles, and locations of human anatomy. This may be enforced through joint training and denoising, as described herein. Thus, the outputs generated by the first generative machine learning model 1210 at least partially reflect the pose map/skeleton 1206 that was provided as structural guidance.

In the method 1100 of FIG. 11, the depth map and the surface normal map as generated by the first generative machine learning model 1210 are used as intermediate outputs 1212. At operation 1110, the second generative machine learning model 1214 takes the initial inputs 1208 and the intermediate outputs 1212 and uses a second neural network to generate a final/full image (e.g., a high-resolution RGB image), shown as an output image 1216 in FIG. 12.

Accordingly, the first generative machine learning model 1210 processes a set of first control signals, which in this case is provided by the text prompt in the user input 1204 and the pose map/skeleton 1206. The text prompt may serve as thematic and/or substantive guidance and the pose skeleton may serve as structural or pose-related guidance. These control signals direct the initial generation process, influencing the creation of the intermediate outputs 1212. The second generative machine learning model 1214 combines the first control signals with predictions generated by the first generative machine learning model 1210 and uses these items as a second set of control signals to guide generation of the output image 1216. The initial predictions from the first generative machine learning model 1210 guide the second generative machine learning model 1214 in refining the details and alignments in the image, which may lead to a more coherent, accurate, or realistic final result. Other control signals may also, or alternatively be used. For example, in some cases, a control signal in the form of an edge outline or edge map may be used.

As mentioned, the first generative machine learning model 1210 and/or the second generative machine learning model 1214 may be provided by diffusion models. For example, the first generative machine learning model 1210 may initialize a noised state associated with each of the plurality of intermediate outputs 1212, and perform denoising by denoising the noised states conditioned on the first control signals. As mentioned, the denoising may be performed by respective branches that share at least some common network layers or blocks within the first generative machine learning model 1210. For example, as mentioned, first and last layers of each branch may be replicated (and thus not shared) while layers between them (e.g., middle layers) may be shared between them.

The image generation system 232 receives the output image 1216 from the AI and machine learning system 230 and causes presentation of the output image at a user device at operation 1112. For example, the image generation system 232 may transmit the output image 1216 (e.g., a final RGB image) for presentation at the user system 102 via the interaction client 104. The output image 1216 may then be used for one or more downstream purposes. For example, the interaction client 104 may apply the output image 1216 in an augmented reality function, such as the virtual try-on function mentioned above.

In some examples, the image generation system 232 processes the output image 1216 first and presents a processed version of the output image 1216 to the user 1202. For example, the image generation system 232 may work with the augmentation system 206 to process the output image 1216 for use in an animated body image augmented reality experience. The user 1202 may download the output image 1216 or apply it as a background at the user system 102, for example. The method 1100 concludes at closing loop element 1114.

### Data Architecture

FIG. 13 is a schematic diagram illustrating data structures 1300, which may be stored in a database, such as the database 128 of the interaction server system 110, according to certain examples. While the content of the database 128 is shown to comprise multiple tables, it will be appreciated that the data could be stored in other types of data structures (e.g., as an object-oriented database).

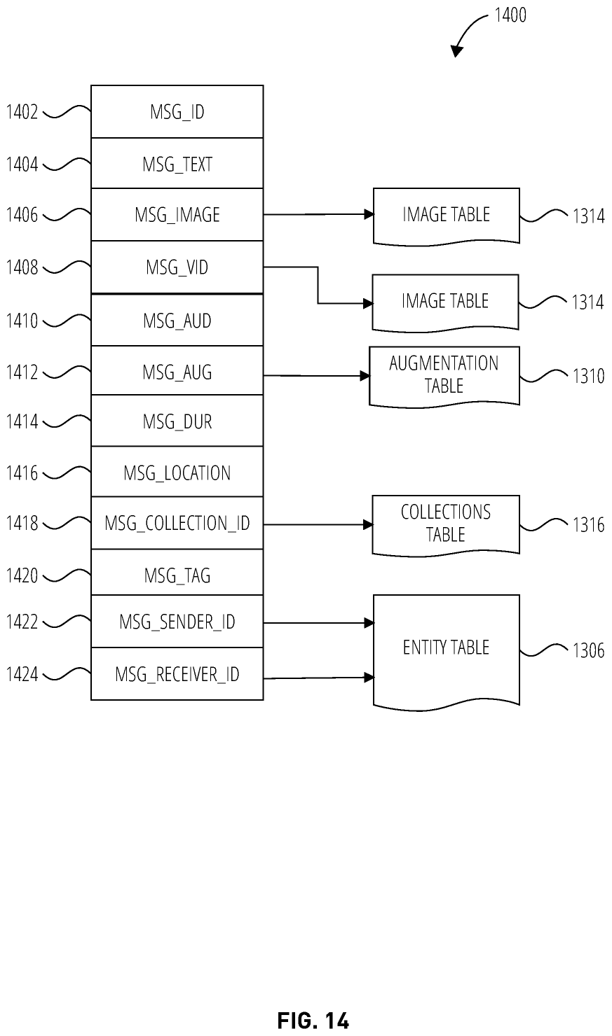

The database 128 includes message data stored within a message table 1304. This message data includes, for any particular message, at least message sender data, message recipient (or receiver) data, and a payload. Further details regarding information that may be included in a message, and included within the message data stored in the message table 1304, are described below with reference to FIG. 14.

An entity table 1306 stores entity data, and is linked (e.g., referentially) to an entity graph 1308 and profile data 1302. Entities for which records are maintained within the entity table 1306 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 1308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 1306. Such privacy settings may be applied to all types of relationships within the context of the interaction system 100, or may selectively be applied to certain types of relationships.

The profile data 1302 stores multiple types of profile data about a particular entity. The profile data 1302 may be selectively used and presented to other users of the interaction system 100 based on privacy settings specified by a particular entity. Where the entity is an individual, the profile data 1302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 1302 for the group may similarly include one or more avatar representations associated with the group, in addition to the group name, members, and various settings (e.g., notifications) for the relevant group.

The database 128 also stores augmentation data, such as overlays or filters, in an augmentation table 1310. The augmentation data is associated with and applied to videos (for which data is stored in a video table 1312) and images (for which data is stored in an image table 1314). As mentioned above, augmentation data may include or be based on AI-generated images. For example, images generated via the image generation system 232 can be utilized in a “virtual try-on” feature or an image animation feature provided on the user system 102 executing the interaction client 104. These images, or processed versions thereof, may thus be stored as part of the augmentation data in the augmentation table 1310.

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 1314 includes augmented reality content items (e.g., corresponding to applying “lenses” or augmented reality experiences). An augmented reality content item may be a real-time special effect and sound that may be added to an image or a video.

The image table 1314 may also store AI-generated images, such as images generated based on user prompts using techniques described herein. For example, where a user has utilized the image generation system 232 to obtain an AI-generated image via the interaction client 104 and sent the image to another user as part of interactions 120 between the users, the database 128 may store the image.

A collections table 1316 stores data regarding collections of messages and associated image, video, or audio data, which are compiled into a collection (e.g., a story or a gallery). The creation of a particular collection may be initiated by a particular user (e.g., each user for which a record is maintained in the entity table 1306). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 1312 stores video data that, in some examples, is associated with messages for which records are maintained within the message table 1304. Similarly, the image table 1314 stores image data associated with messages for which message data is stored in the entity table 1306, including, for example, AI-generated images as mentioned above. The entity table 1306 may associate various augmentations from the augmentation table 1310 with various images and videos stored in the image table 1314 and the video table 1312.

A prompts table 1318 may store one or more prompts that are or may be used with respect to the AI and machine learning system 230. For example, the prompts table 1318 may store prompts that can be selected by a user for automatic image generation via the image generation system 232, where the interaction client 104 provides the user with access to automatic image generation functionality.

### Data Communications Architecture

FIG. 14 is a schematic diagram illustrating a structure of a message 1400, according to some examples, generated by an interaction client 104 for communication to a further interaction client 104 via the interaction servers 124. The content of a particular message 1400 may be used to populate the message table 1304 stored within the database 128 of FIG. 1, accessible by the interaction servers 124. Similarly, the content of a message 1400 is stored in memory as “in-transit” or “in-flight” data of the user system 102 or the interaction servers 124. A message 1400 is shown to include the following example components:
Message identifier 1402: a unique identifier that identifies the message 1400.
Message text payload 1404: text, to be generated by a user via a user interface of the user system 102, and that is included in the message 1400.
Message image payload 1406: image data, captured by a camera component of a user system 102, retrieved from a memory component of a user system 102, or automatically generated using the image generation system 232 and the AI and machine learning system 230, and that is included in the message 1400. Image data for a sent or received message 1400 may be stored in the image table 1314.
Message video payload 1408: video data, captured by a camera component or retrieved from a memory component of the user system 102, and that is included in the message 1400. Video data for a sent or received message 1400 may be stored in the image table 1314.
Message audio payload 1410: audio data, captured by a microphone or retrieved from a memory component of the user system 102, and that is included in the message 1400.
Message augmentation data 1412: augmentation data (e.g., filters, stickers, or other annotations or enhancements) that represents augmentations to be applied to message image payload 1406, message video payload 1408, or message audio payload 1410 of the message 1400. Augmentation data for a sent or received message 1400 may be stored in the augmentation table 1310.
Message duration parameter 1414: parameter value indicating, in seconds, the amount of time for which content of the message (e.g., the message image payload 1406, message video payload 1408, message audio payload 1410) is to be presented or made accessible to a user via the interaction client 104.
Message geolocation parameter 1416: geolocation data (e.g., latitudinal and longitudinal coordinates) associated with the content payload of the message. Multiple message geolocation parameter 1416 values may be included in the payload, each of these parameter values being associated with respect to content items included in the content (e.g., a specific image within the message image payload 1406, or a specific video in the message video payload 1408).
Message collection identifier 1418: identifier values identifying one or more content collections (e.g., “stories” identified in the collections table 1316) with which a particular content item in the message image payload 1406 of the message 1400 is associated. For example, multiple images within the message image payload 1406 may each be associated with multiple content collections using identifier values.
Message tag 1420: each message 1400 may be tagged with multiple tags, each of which is indicative of the subject matter of content included in the message payload. For example, where a particular image included in the message image payload 1406 depicts an animal (e.g., a lion), a tag value may be included within the message tag 1420 that is indicative of the relevant animal. Tag values may be generated manually, based on user input, or may be automatically generated using, for example, image recognition.
Message sender identifier 1422: an identifier (e.g., a messaging system identifier, email address, or device identifier) indicative of a user of the user system 102 on which the message 1400 was generated and from which the message 1400 was sent.
Message receiver identifier 1424: an identifier (e.g., a messaging system identifier, email address, or device identifier) indicative of a user of the user system 102 to which the message 1400 is addressed.

The contents (e.g., values) of the various components of message 1400 may be pointers to locations in tables within which content data values are stored. For example, an image value in the message image payload 1406 may be a pointer to (or address of) a location within an image table 1314. Similarly, values within the message video payload 1408 may point to data stored within an image table 1314, values stored within the message augmentation data 1412 may point to data stored in an augmentation table 1310, values stored within the message collection identifier 1418 may point to data stored in a collections table 1316, and values stored within the message sender identifier 1422 and the message receiver identifier 1424 may point to user records stored within an entity table 1306.

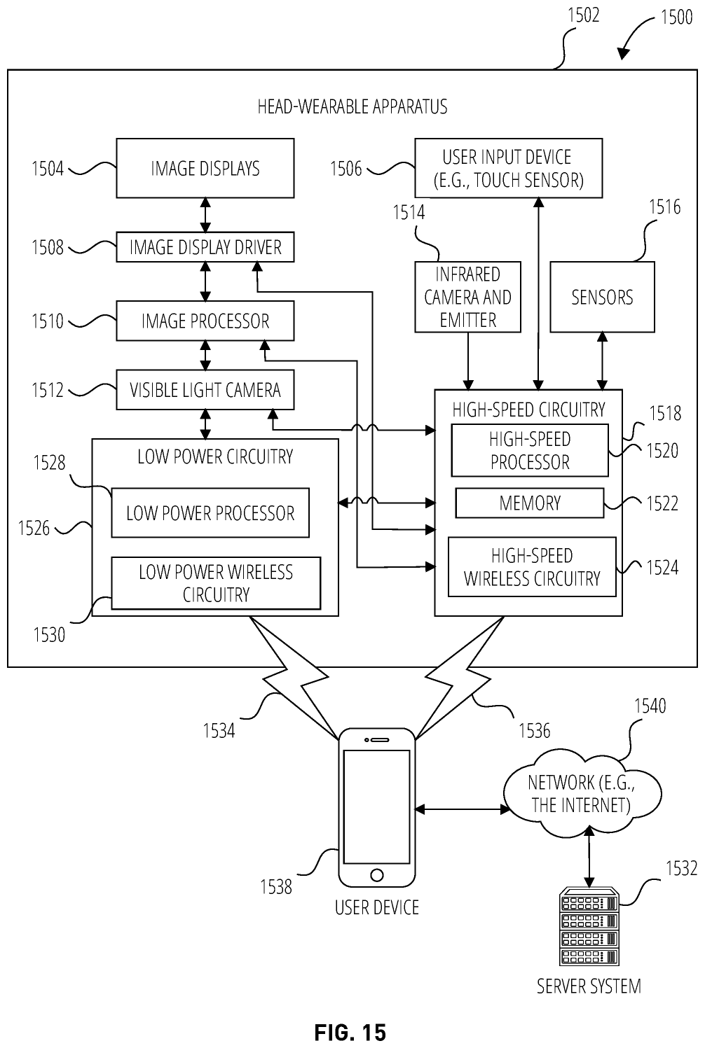

FIG. 15 illustrates a network environment 1500 in which a head-wearable apparatus 1502, such a head-wearable augmented reality or extended reality device, can be implemented according to some examples. FIG. 15 provides a high-level functional block diagram of an example head-wearable apparatus 1502 communicatively coupled a mobile user device 1538 and a server system 1532 via a suitable network 1540. One or more of the techniques described herein may be performed using the head-wearable apparatus 1502 or a network of devices similar to those shown in FIG. 15.

The head-wearable apparatus 1502 includes a camera, such as at least one of a visible light camera 1512 and an infrared camera and emitter 1514. The head-wearable apparatus 1502 includes other sensors 1516, such as motion sensors or eye tracking sensors. The user device 1538 can be capable of connecting with head-wearable apparatus 1502 using both a communication link 1534 and a communication link 1536. The user device 1538 is connected to the server system 1532 via the network 1540. The network 1540 may include any combination of wired and wireless connections.

The head-wearable apparatus 1502 includes a display arrangement that has several components. The arrangement includes two image displays 1504 of an optical assembly. For example, the two displays include one associated with the left lateral side and one associated with the right lateral side of the head-wearable apparatus 1502. The head-wearable apparatus 1502 also includes an image display driver 1508, an image processor 1510, low power circuitry 1526, and high-speed circuitry 1518. The image displays 1504 are for presenting images and videos, including an image that can provide a graphical user interface to a user of the head-wearable apparatus 1502.

The image display driver 1508 commands and controls the image display of each of the image displays 1504. The image display driver 1508 may deliver image data directly to each image display of the image displays 1504 for presentation or may have to convert the image data into a signal or data format suitable for delivery to each image display device. For example, the image data may be video data formatted according to compression formats, such as H. 264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (Exif) or the like.

The head-wearable apparatus 1502 may include a frame and stems (or temples) extending from a lateral side of the frame, or another component to facilitate wearing of the head-wearable apparatus 1502 by a user. The head-wearable apparatus 1502 of FIG. 15 further includes a user input device 1506 (e.g., touch sensor or push button) including an input surface on the head-wearable apparatus 1502. The user input device 1506 is configured to receive, from the user, an input selection to manipulate the graphical user interface of the presented image.

The components shown in FIG. 15 for the head-wearable apparatus 1502 are located on one or more circuit boards, for example a printed circuit board (PCB) or flexible PCB, in the rims or temples. Alternatively, or additionally, the depicted components can be located in the chunks, frames, hinges, or bridges of the head-wearable apparatus 1502. Left and right sides of the head-wearable apparatus 1502 can each include a digital camera element such as a complementary metal-oxide-semiconductor (CMOS) image sensor, charge coupled device, a camera lens, or any other respective visible or light capturing elements that may be used to capture data, including images of scenes with unknown objects.

The head-wearable apparatus 1502 includes a memory 1522 which stores instructions to perform a subset or all of the functions described herein. The memory 1522 can also include a storage device. As further shown in FIG. 15, the high-speed circuitry 1518 includes a high-speed processor 1520, the memory 1522, and high-speed wireless circuitry 1524. In FIG. 15, the image display driver 1508 is coupled to the high-speed circuitry 1518 and operated by the high-speed processor 1520 in order to drive the left and right image displays of the image displays 1504. The high-speed processor 1520 may be any processor capable of managing high-speed communications and operation of any general computing system needed for the head-wearable apparatus 1502. The high-speed processor 1520 includes processing resources needed for managing high-speed data transfers over the communication link 1536 to a wireless local area network (WLAN) using high-speed wireless circuitry 1524. In certain examples, the high-speed processor 1520 executes an operating system such as a LINUX operating system or other such operating system of the head-wearable apparatus 1502 and the operating system is stored in memory 1522 for execution. In addition to any other responsibilities, the high-speed processor 1520 executing a software architecture for the head-wearable apparatus 1502 is used to manage data transfers with high-speed wireless circuitry 1524. In certain examples, high-speed wireless circuitry 1524 is configured to implement Institute of Electrical and Electronic Engineers (IEEE) 1502.11 communication standards, also referred to herein as Wi-Fi™. In other examples, other high-speed communications standards may be implemented by high-speed wireless circuitry 1524.

The low power wireless circuitry 1530 and the high-speed wireless circuitry 1524 of the head-wearable apparatus 1502 can include short range transceivers (Bluetooth™) and wireless wide, local, or wide area network transceivers (e.g., cellular or Wi-Fi™). The user device 1538, including the transceivers communicating via the communication link 1534 and communication link 1536, may be implemented using details of the architecture of the head-wearable apparatus 1502, as can other elements of the network 1540.

The memory 1522 includes any storage device capable of storing various data and applications, including, among other things, camera data generated by the visible light camera 1512, sensors 1516, and the image processor 1510, as well as images generated for display by the image display driver 1508 on the image displays 1504. While the memory 1522 is shown as integrated with the high-speed circuitry 1518, in other examples, the memory 1522 may be an independent standalone element of the head-wearable apparatus 1502. In certain such examples, electrical routing lines may provide a connection through a chip that includes the high-speed processor 1520 from the image processor 1510 or low power processor 1528 to the memory 1522. In other examples, the high-speed processor 1520 may manage addressing of memory 1522 such that the low power processor 1528 will boot the high-speed processor 1520 any time that a read or write operation involving memory 1522 is needed.

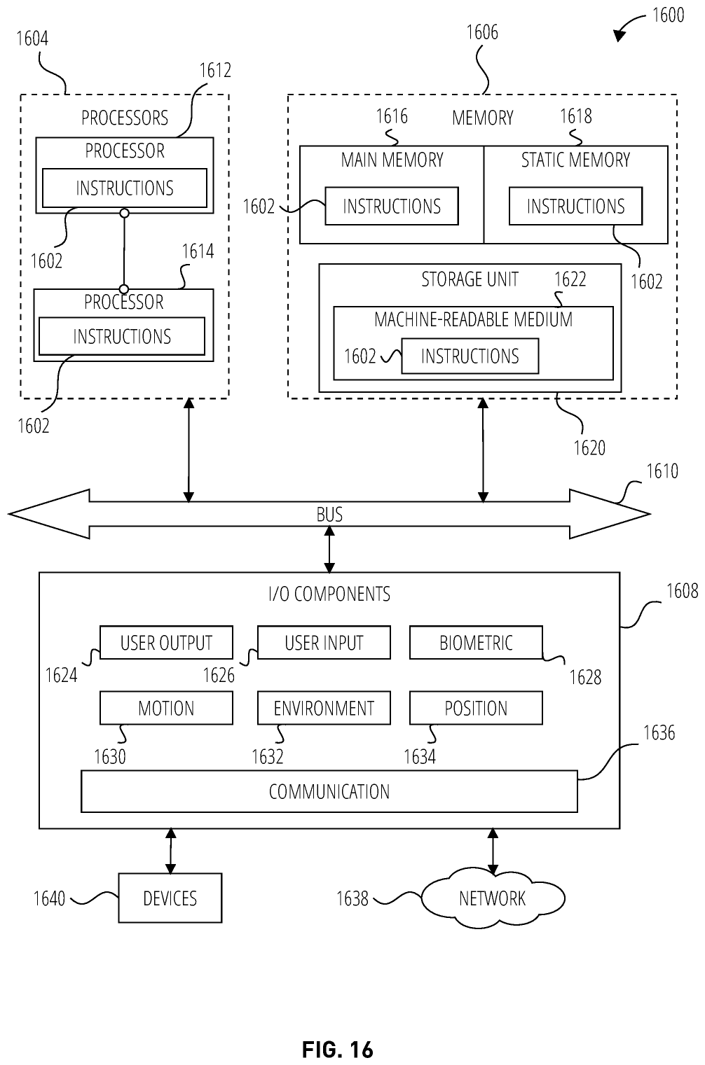

As shown in FIG. 15, the low power processor 1528 or high-speed processor 1520 of the head-wearable apparatus 1502 can be coupled to the camera (visible light camera 1512, or infrared camera and emitter 1514), the image display driver 1508, the user input device 1506 (e.g., touch sensor or push button), and the memory 1522. The head-wearable apparatus 1502 also includes sensors 1516, which may be the motion components 1630, position components 1634, environmental components 1632, and biometric components 1628, e.g., as described below with reference to FIG. 16. In particular, motion components 1630 and position components 1634 are used by the head-wearable apparatus 1502 to determine and keep track of the position and orientation (the “pose”) of the head-wearable apparatus 1502 relative to a frame of reference or another object, in conjunction with a video feed from one of the visible light cameras 1512, using for example techniques such as structure from motion (SfM) or VIO.

In some examples, and as shown in FIG. 15, the head-wearable apparatus 1502 is connected with a host computer. For example, the head-wearable apparatus 1502 is paired with the user device 1538 via the communication link 1536 or connected to the server system 1532 via the network 1540. The server system 1532 may be one or more computing devices as part of a service or network computing system, for example, that include a processor, a memory, and network communication interface to communicate over the network 1540 with the user device 1538 and head-wearable apparatus 1502.

The user device 1538 includes a processor and a network communication interface coupled to the processor. The network communication interface allows for communication over the network 1540, communication link 1534 or communication link 1536. The user device 1538 can further store at least portions of the instructions for implementing functionality described herein.

Output components of the head-wearable apparatus 1502 include visual components, such as a display (e.g., one or more liquid-crystal display (LCD)), one or more plasma display panel (PDP), one or more light emitting diode (LED) display, one or more projector, or one or more waveguide. The image displays 1504 of the optical assembly are driven by the image display driver 1508. The output components of the head-wearable apparatus 1502 further include acoustic components (e.g., speakers), haptic components (e.g., a vibratory motor), other signal generators, and so forth. The input components of the head-wearable apparatus 1502, the user device 1538, and server system 1532, such as the user input device 1506, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 1502 may optionally include additional peripheral device elements. Such peripheral device elements may include biometric sensors, additional sensors, or display elements integrated with the head-wearable apparatus 1502. For example, peripheral device elements may include any I/O components including output components, motion components, position components, or any other such elements described herein.

For example, the biometric components include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi™ or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over a communication link 1536 from the user device 1538 via the low power wireless circuitry 1530 or high-speed wireless circuitry 1524.

Any biometric data collected by the biometric components is captured and stored with only user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

### Machine Architecture

FIG. 16 is a diagrammatic representation of a machine 1600 within which instructions 1602 (e.g., software, a program, an application, an applet, an app, or other executable code) for causing the machine 1600 to perform any one or more of the methodologies discussed herein may be executed. For example, the instructions 1602 may cause the machine 1600 to execute any one or more of the methods described herein. The instructions 1602 transform the general, non-programmed machine 1600 into a particular machine 1600 programmed to carry out the described and illustrated functions in the manner described. The machine 1600 may operate as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1602, sequentially or otherwise, that specify actions to be taken by the machine 1600. Further, while a single machine 1600 is illustrated, the term “machine” shall also be taken to include a collection of machines that individually or jointly execute the instructions 1602 to perform any one or more of the methodologies discussed herein. The machine 1600, for example, may comprise the user system 102 or any one of multiple server devices forming part of the interaction server system 110. In some examples, the machine 1600 may also comprise both client and server systems, with certain operations of a particular method or algorithm being performed on the server-side and with certain operations of the particular method or algorithm being performed on the client-side.

The machine 1600 may include processors 1604, memory 1606, and input/output I/O components 1608, which may be configured to communicate with each other via a bus 1610. In an example, the processors 1604 may include, for example, a processor 1612 and a processor 1614 that execute the instructions 1602.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware.

Referring again to FIG. 16, although FIG. 16 shows multiple processors 1604, the machine 1600 may include a single processor with a single-core, a single processor with multiple cores (e.g., a multi-core processor), multiple processors with a single core, multiple processors with multiples cores, or any combination thereof. The memory 1606 includes a main memory 1616, a static memory 1618, and a storage unit 1620, all accessible to the processors 1604 via the bus 1610. The main memory 1606, the static memory 1618, and storage unit 1620 store the instructions 1602 embodying any one or more of the methodologies or functions described herein. The instructions 1602 may also reside, completely or partially, within the main memory 1616, within the static memory 1618, within machine-readable medium 1622 within the storage unit 1620, within at least one of the processors 1604 (e.g., within the processor's cache memory), or any suitable combination thereof, during execution thereof by the machine 1600.

The I/O components 1608 may include a wide variety of components to receive input, provide output, produce output, transmit information, exchange information, capture measurements, and so on. The specific I/O components 1608 that are included in a particular machine will depend on the type of machine. For example, portable machines such as mobile phones may include a touch input device or other such input mechanisms, while a headless server machine will likely not include such a touch input device. It will be appreciated that the I/O components 1608 may include many other components that are not shown in FIG. 16. In various examples, the I/O components 1608 may include user output components 1624 and user input components 1626. The user output components 1624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1608 may include biometric components 1628, motion components 1630, environmental components 1632, or position components 1634, among a wide array of other components. For example, the biometric components 1628 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

The motion components 1630 include acceleration sensor components (e.g., accelerometer), gravitation sensor components, and/or rotation sensor components (e.g., gyroscope).

The environmental components 1632 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple camera systems may include a wide camera, an ultra-wide camera, a telephoto camera, a macro camera, and a depth sensor, for example.

The position components 1634 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1608 further include communication components 1636 operable to couple the machine 1600 to a network 1638 or devices 1640 via respective coupling or connections. For example, the communication components 1636 may include a network interface component or another suitable device to interface with the network 1638. In further examples, the communication components 1636 may include wired communication components, wireless communication components, cellular communication components, Near Field Communication (NFC) components, Bluetooth™ components (e.g., Bluetooth™ Low Energy), Wi-Fi components, and other communication components to provide communication via other modalities. The devices 1640 may be another machine or any of a wide variety of peripheral devices (e.g., a peripheral device coupled via a USB).

Moreover, the communication components 1636 may detect identifiers or include components operable to detect identifiers. For example, the communication components 1636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1636, such as location via Internet Protocol (IP) geolocation, location via Wi-Fi® signal triangulation, location via detecting an NFC beacon signal that may indicate a particular location, and so forth.

The various memories (e.g., main memory 1616, static memory 1618, and memory of the processors 1604) and storage unit 1620 may store one or more sets of instructions and data structures (e.g., software) embodying or used by any one or more of the methodologies or functions described herein. These instructions (e.g., the instructions 1602), when executed by processors 1604, cause various operations to implement the disclosed examples.

The instructions 1602 may be transmitted or received over the network 1638, using a transmission medium, via a network interface device (e.g., a network interface component included in the communication components 1636) and using any one of several well-known transfer protocols (e.g., hypertext transfer protocol (HTTP)). Similarly, the instructions 1602 may be transmitted or received using a transmission medium via a coupling (e.g., a peer-to-peer coupling) to the devices 1640.

### Software Architecture

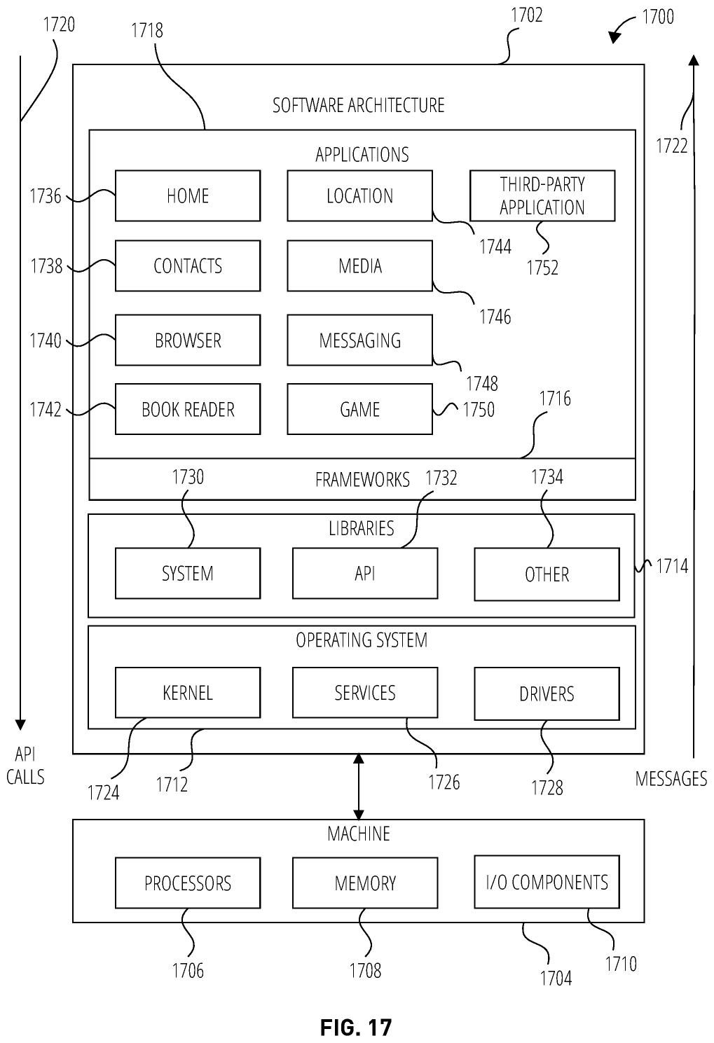

FIG. 17 is a block diagram 1700 illustrating a software architecture 1702, which can be installed on any one or more of the devices described herein. The software architecture 1702 is supported by hardware such as a machine 1704 that includes processors 1706, memory 1708, and I/O components 1710. In this example, the software architecture 1702 can be conceptualized as a stack of layers, where each layer provides a particular functionality. The software architecture 1702 includes layers such as an operating system 1712, libraries 1714, frameworks 1716, and applications 1718. Operationally, the applications 1718 invoke API calls 1720 through the software stack and receive messages 1722 in response to the API calls 1720.

The operating system 1712 manages hardware resources and provides common services. The operating system 1712 includes, for example, a kernel 1724, services 1726, and drivers 1728. The kernel 1724 acts as an abstraction layer between the hardware and the other software layers. For example, the kernel 1724 provides memory management, processor management (e.g., scheduling), component management, networking, and security settings, among other functionalities. The services 1726 can provide other common services for the other software layers. The drivers 1728 are responsible for controlling or interfacing with the underlying hardware. For instance, the drivers 1728 can include display drivers, camera drivers, Bluetooth™ or Bluetooth™ Low Energy drivers, flash memory drivers, serial communication drivers (e.g., USB drivers), WI-FI drivers, audio drivers, power management drivers, and so forth.

The libraries 1714 provide a common low-level infrastructure used by the applications 1718. The libraries 1714 can include system libraries 1730 (e.g., C standard library) that provide functions such as memory allocation functions, string manipulation functions, mathematic functions, and the like. In addition, the libraries 1714 can include API libraries 1732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in 2D and 3D in a graphic content on a display), database libraries (e.g., SQLite to provide various relational database functions), web libraries (e.g., WebKit to provide web browsing functionality), and the like. The libraries 1714 can also include a wide variety of other libraries 1734 to provide many other APIs to the applications 1718.

The frameworks 1716 provide a common high-level infrastructure that is used by the applications 1718. For example, the frameworks 1716 provide various graphical user interface (GUI) functions, high-level resource management, and high-level location services. The frameworks 1716 can provide a broad spectrum of other APIs that can be used by the applications 1718, some of which may be specific to a particular operating system or platform.

In an example, the applications 1718 may include a home application 1736, a contacts application 1738, a browser application 1740, a book reader application 1742, a location application 1744, a media application 1746, a messaging application 1748, a game application 1750, and a broad assortment of other applications such as a third-party application 1752. The applications 1718 are programs that execute functions defined in the programs. Various programming languages can be employed to create one or more of the applications 1718, structured in a variety of manners, such as object-oriented programming languages (e.g., Objective-C, Java, or C++) or procedural programming languages (e.g., C or assembly language). In a specific example, the third-party application 1752 (e.g., an application developed using the ANDROID™ or IOS™ SDK by an entity other than the vendor of the particular platform) may be mobile software running on a mobile operating system such as IOS™, ANDROID™, WINDOWS® Phone, or another mobile operating system. In this example, the third-party application 1752 can invoke the API calls 1720 provided by the operating system 1712 to facilitate functionalities described herein.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: accessing a plurality of inputs comprising first input data and second input data, the first input data comprising a text prompt describing a desired image and the second input data indicative of one or more structural features of the desired image; generating one or more intermediate outputs via a first generative machine learning model that uses the plurality of inputs as first control signals; generating an output image via a second generative machine learning model that uses at least a subset of the plurality of inputs and at least a subset of the one or more intermediate outputs as second control signals; and causing presentation of the output image at a user device of a user.

In Example 2, the subject matter of Example 1 includes, wherein the one or more intermediate outputs comprises a plurality of intermediate outputs among which the one or more structural features are spatially aligned.

In Example 3, the subject matter of any of Examples 1-2 includes, wherein the one or more intermediate outputs comprises at least one of: a depth map, a surface normal map, a color image, a pose map, or an edge map.

In Example 4, the subject matter of any of Examples 1-3 includes, wherein the first generative machine learning model comprises a diffusion model, and the one or more intermediate outputs comprise a plurality of intermediate outputs that are at least partially simultaneously denoised via the diffusion model.

In Example 5, the subject matter of Example 4 includes, wherein the generating of the plurality of intermediate outputs comprises: initializing a noised state associated with each of the plurality of intermediate outputs; and performing denoising by denoising the noised states conditioned on the first control signals.

In Example 6, the subject matter of any of Examples 4-5 includes, wherein the first generative machine learning model comprises a set of branches, and each branch in the set of branches is configured to denoise a respective one of the plurality of intermediate outputs.

In Example 7, the subject matter of Example 6 includes, wherein the first generative machine learning model comprises one or more common neural network layers that are shared across the set of branches.

In Example 8, the subject matter of any of Examples 1-7 includes, wherein the first generative machine learning model comprises a latent diffusion model.

In Example 9, the subject matter of any of Examples 1-8 includes, the operations further comprising: generating the second input data based on a reference image that contains the one or more structural features of the desired image.

In Example 10, the subject matter of any of Examples 1-9 includes, wherein the second input data comprises pose data that indicates the one or more structural features of the desired image, and the first generative machine learning model is trained to at least partially reflect the pose data in the one or more intermediate outputs.

In Example 11, the subject matter of Example 10 includes, wherein the pose data comprises human pose data, the one or more structural features of the desired image comprises a pose of at least one human in the desired image, and the output image depicts the at least one human.

In Example 12, the subject matter of any of Examples 10-11 includes, wherein the pose data comprises a pose map that defines at least one body skeleton.

In Example 13, the subject matter of any of Examples 10-12 includes, wherein the one or more intermediate outputs comprise a depth map and a surface normal map, the first generative machine learning model is trained to generate the depth map and the surface normal map based at least partially on the pose data and the text prompt, and the depth map and the surface normal map are processed via the second generative machine learning model to generate the output image.

In Example 14, the subject matter of Examples 1-13 includes, wherein the one or more intermediate outputs comprises a predicted color image and one or more additional intermediate outputs, and the one or more additional intermediate outputs comprises at least one of: a depth map, a surface normal map, a pose map, or an edge map.

In Example 15, the subject matter of Example 14 includes, wherein the subset of the one or more intermediate outputs includes the one or more additional intermediate outputs, the predicted color image being excluded from the subset of the one or more intermediate outputs such that the predicted color image is not processed via the second generative machine learning model.

In Example 16, the subject matter of any of Examples 1-15 includes, wherein the second generative machine learning model comprises a diffusion model, and training of the second generative machine learning model comprises implementing a dropout scheme with respect to at least one of the second control signals processed via the second machine learning model.

In Example 17, the subject matter of any of Examples 1-16 includes, the operations further comprising: receiving user input comprising at least the text prompt from the user device, wherein the output image is caused to be presented at the user device of the user in response to receiving the user input.

In Example 18, the subject matter of Example 17 includes, wherein the user input is received via an interaction application executing at the user device, and the interaction application provides an augmented reality experience that utilizes the output image.

Example 19 is a method comprising: accessing a plurality of inputs comprising first input data and second input data, the first input data comprising a text prompt describing a desired image and the second input data indicative of one or more structural features of the desired image; generating one or more intermediate outputs via a first generative machine learning model that uses the plurality of inputs as first control signals; generating an output image via a second generative machine learning model that uses at least a subset of the plurality of inputs and at least a subset of the one or more intermediate outputs as second control signals; and causing presentation of the output image at a user device of a user.

Example 20 is a non-transitory computer-readable storage medium storing instructions that, when executed by at least one processor, cause the at least one processor to perform operations comprising: accessing a plurality of inputs comprising first input data and second input data, the first input data comprising a text prompt describing a desired image and the second input data indicative of one or more structural features of the desired image; generating one or more intermediate outputs via a first generative machine learning model that uses the plurality of inputs as first control signals; generating an output image via a second generative machine learning model that uses at least a subset of the plurality of inputs and at least a subset of the one or more intermediate outputs as second control signals; and causing presentation of the output image at a user device of a user.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

### CONCLUSION

Accordingly, in some examples, a framework for generating “in-the-wild” images, such as human images, of high quality is provided. To enforce joint learning of image appearance, spatial relationship, and geometry in a unified network, a latent structural diffusion model may be provided that is trained to simultaneously synthesize (e.g., denoise) intermediate signals, such as a depth image and a surface normal image (or other images with structural features), optionally along with an RGB image.

Then, a structure-guided refiner can be used to compose predicted conditions (possibly together with original inputs, such as a pose map and caption) for more detailed generation. In some examples, the structure-guided refiner uses the intermediate signals to render a high-quality image at a higher resolution. The final output may be an image that is not only realistic and detailed, but also aligns with the input text prompt and pose data, based on the additional structural guidance provided by the depth image and surface normal image generated by the latent structural diffusion model.

In some examples, images generated using models described herein can be labeled as “synthetic” (or other labels with a similar meaning) to confirm or inform users (e.g., users of an interaction system) that they are AI-generated.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the disclosure, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another, or may be combined in various ways. All possible combinations and subcombinations are intended to fall within the scope of this disclosure. In addition, certain method or process blocks or operations may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device,” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a manner as to encode information in the signal. The terms “transmission medium” and “signal medium” mean the same thing and may be used interchangeably in this disclosure.

“User device” refers, for example, to a device accessed, controlled, or owned by a user and with which the user interacts to perform an action, or interaction on the user device, including an interaction with other users or computer systems.

1. A system comprising:
at least one processor; and
at least one memory component storing instructions that, when executed by the at least one processor, cause the at least one processor to perform operations comprising:
accessing a plurality of inputs comprising first input data and second input data, the first input data comprising a text prompt describing a desired image and the second input data indicative of one or more structural features of the desired image;
generating one or more intermediate outputs via a first generative machine learning model that uses the plurality of inputs as first control signals;
generating an output image via a second generative machine learning model that uses at least a subset of the plurality of inputs and at least a subset of the one or more intermediate outputs as second control signals; and
causing presentation of the output image at a user device of a user.

2. The system of claim 1, wherein the one or more intermediate outputs comprises a plurality of intermediate outputs among which the one or more structural features are spatially aligned.

3. The system of claim 1, wherein the one or more intermediate outputs comprises at least one of: a depth map, a surface normal map, a color image, a pose map, or an edge map.

4. The system of claim 1, wherein the first generative machine learning model comprises a diffusion model, and the one or more intermediate outputs comprise a plurality of intermediate outputs that are at least partially simultaneously denoised via the diffusion model.

5. The system of claim 4, wherein the generating of the plurality of intermediate outputs comprises:
initializing a noised state associated with each of the plurality of intermediate outputs; and
performing denoising by denoising the noised states conditioned on the first control signals.

6. The system of claim 4, wherein the first generative machine learning model comprises a set of branches, and each branch in the set of branches is configured to denoise a respective one of the plurality of intermediate outputs.

7. The system of claim 6, wherein the first generative machine learning model comprises one or more common neural network layers that are shared across the set of branches.

8. The system of claim 1, wherein the first generative machine learning model comprises a latent diffusion model.

9. The system of claim 1, the operations further comprising:
generating the second input data based on a reference image that contains the one or more structural features of the desired image.

10. The system of claim 1, wherein the second input data comprises pose data that indicates the one or more structural features of the desired image, and the first generative machine learning model is trained to at least partially reflect the pose data in the one or more intermediate outputs.

11. The system of claim 10, wherein the pose data comprises human pose data, the one or more structural features of the desired image comprises a pose of at least one human in the desired image, and the output image depicts the at least one human.

12. The system of claim 10, wherein the pose data comprises a pose map that defines at least one body skeleton.

13. The system of claim 10, wherein the one or more intermediate outputs comprise a depth map and a surface normal map, the first generative machine learning model is trained to generate the depth map and the surface normal map based at least partially on the pose data and the text prompt, and the depth map and the surface normal map are processed via the second generative machine learning model to generate the output image.

14. The system of claim 1, wherein the one or more intermediate outputs comprises a predicted color image and one or more additional intermediate outputs, and the one or more additional intermediate outputs comprises at least one of: a depth map, a surface normal map, a pose map, or an edge map.

15. The system of claim 14, wherein the subset of the one or more intermediate outputs includes the one or more additional intermediate outputs, the predicted color image being excluded from the subset of the one or more intermediate outputs such that the predicted color image is not processed via the second generative machine learning model.

16. The system of claim 1, wherein the second generative machine learning model comprises a diffusion model, and training of the second generative machine learning model comprises implementing a dropout scheme with respect to at least one of the second control signals processed via the second machine learning model.

17. The system of claim 1, the operations further comprising:
receiving user input comprising at least the text prompt from the user device, wherein the output image is caused to be presented at the user device of the user in response to receiving the user input.

18. The system of claim 17, wherein the user input is received via an interaction application executing at the user device, and the interaction application provides an augmented reality experience that utilizes the output image.

19. A method comprising:
accessing a plurality of inputs comprising first input data and second input data, the first input data comprising a text prompt describing a desired image and the second input data indicative of one or more structural features of the desired image;
generating one or more intermediate outputs via a first generative machine learning model that uses the plurality of inputs as first control signals;
generating an output image via a second generative machine learning model that uses at least a subset of the plurality of inputs and at least a subset of the one or more intermediate outputs as second control signals; and
causing presentation of the output image at a user device of a user.

20. A non-transitory computer-readable storage medium storing instructions that, when executed by at least one processor, cause the at least one processor to perform operations comprising:
accessing a plurality of inputs comprising first input data and second input data, the first input data comprising a text prompt describing a desired image and the second input data indicative of one or more structural features of the desired image;
generating one or more intermediate outputs via a first generative machine learning model that uses the plurality of inputs as first control signals;
generating an output image via a second generative machine learning model that uses at least a subset of the plurality of inputs and at least a subset of the one or more intermediate outputs as second control signals; and
causing presentation of the output image at a user device of a user.
